(19) United States
(12) Patent Application Publication
(10) Pub. No.: US 2020/0268203 A1
(43) Pub. Date: Aug. 27, 2020

(54) Carriage Apparatuses for a Grill and Methods for Using Carriage Apparatuses for a Grill

(71) Applicant: Johnny Lapeere Bacot, JR., Rathdrum, ID (US)

(72) Inventor: Johnny Lapeere Bacot, JR., Rathdrum, ID (US)

(21) Appl. No.: 16/284,752

(22) Filed: Feb. 25, 2019

(51) Int. Cl. A47J 37/07; B62B 1/12

(52) U.S. Cl. CPC A47J 37/0763; B62B 1/14; B62B 1/125

(57) ABSTRACT

A carriage apparatus for a grill includes a frame having a first end opposite a second end. A pair of wheels are secured at the first end of the frame. A handle extends from the second end of the frame. The carriage apparatus includes at least one quick-release connector. The at least one quick-release connector includes a support structure secured to the frame. The at least one quick-release connector further includes a release device supported upon the support structure. The at least one quick-release connector further includes an elastic member that biases the release device against the support structure.

### TECHNICAL FIELD

This invention relates to carriage apparatuses for a grill and methods for using carriage apparatuses for a grill.

### BACKGROUND OF THE INVENTION

Portable grills are, by definition, portable, and therefore, routinely are transported to desired places of use. Since grills are for providing fire, safety should always Portable grills are, by definition, portable, and therefore, routinely are transported to desired places of use. Since grills are for providing fire, safety should always be at the forefront of your decision making when using grills. Now consider marine grills (marine barbeque, boat grill or barbeque). Most would agree that the most important aspect of family boating is safety even without a grill. Include a marine grill and the need for keeping safety at forefront of all decision is magnified intensely. However, from most boater's perspective, there is nothing quite like dropping anchor in a serene cove and firing up the grill to conclude the day on the water with a fine meal. Moreover, because marine grills are located above decks proximate water, there exists a tendency for boaters to treat marine grills with a more cavalier attitude than grills on land. Safety and precautions when using marine grills should be a major concern for all boaters.

Accordingly, there is a need to design an apparatus that will easily, quickly, conveniently and most importantly safely, remove the risk of fire on a boat resulting from use of a marine grill.

While the invention was motivated for designing an apparatus that will solve the above listed issues, it is in no way so limited. The invention is only limited by the accompanying claims as literally worded, without interpretative or other limiting reference to the specification, and in accordance with the doctrine of equivalents.

Other aspects and implementations are contemplated.

### BRIEF DESCRIPTION OF THE DRAWINGS

Preferred embodiments of the invention are described below with reference to the following accompanying drawings.

FIG. 1 illustrates a perspective view of an inventive carriage apparatus with a grill according to an embodiment of the invention;

FIG. 2 is a side view of the FIG. 1 embodiment supported upon a substrate;

FIG. 3 is a side view of the FIG. 1 embodiment illustrated not supported upon a substrate;

FIG. 4 is a top view of the FIG. 1 embodiment;

FIG. 5 is a perspective view of the invention according to an embodiment of the invention;

FIG. 6 is a side view of the FIG. 5 embodiment;

FIG. 7 is a top view of the FIG. 5 embodiment;

FIG. 8 is an elevational view of an exemplary stand device according to an embodiment of the invention;

FIGS. 9-12 are various views of an exemplary engagement device for the stand device according to an embodiment of the invention;

FIG. 13 is a side view of an exemplary mating/swivel device of the invention in a separated or released position according to an embodiment of the invention;

FIGS. 14-17 are various views of an exemplary plunger device for the mating/swivel device according to an embodiment of the invention;

FIG. 18 is a side view of an exemplary male component for the mating/swivel device according to an embodiment of the invention;

FIG. 19 is another side view of the male component taken at 90 degrees from the FIG. 18 view;

FIG. 20 is a sectional view of the male component taken along the sectional lines 20-20 illustrated in FIG. 18;

FIG. 21 is a top plan view of the male component for the mating/swivel device according to an embodiment of the invention;

FIGS. 22-25 are various views of exemplary inner mechanical structure and cooperation of the male component for the mating/swivel device according to an embodiment of the invention;

FIGS. 23-29D are various views of an exemplary quick-release connector, and interaction/cooperation views thereof, according to an embodiment of the invention;

FIG. 30 illustrates a perspective view of an inventive carriage apparatus with a grill according to another embodiment of the invention;

FIG. 31 illustrates an exemplary method step of use of the carriage apparatus with the grill of FIG. 30 according to an embodiment of the invention;

FIG. 32 is a perspective view of a portion of a wall of an exemplary boat having structures configured for use with an inventive carriage apparatus according to an embodiment of the invention;

FIG. 33 is a close-up perspective view of an exemplary male connector illustrated in FIG. 32 and configured for use with an inventive carriage apparatus according to an embodiment of the invention;

FIG. 34 is a close-up sectional view of an exemplary protective bolt illustrated in FIG. 32 and used in cooperation with an inventive carriage apparatus according to an embodiment of the invention;

FIG. 35 illustrates the FIG. 32 boat wall prepared for use with an inventive carriage apparatus according to an embodiment of the invention;

FIG. 36 illustrates an exemplary method step of use of the carriage apparatus on a boat, subsequent to the preparation step of FIG. 35, according to an embodiment of the invention;

FIG. 37 illustrates an exemplary method step of use of the carriage apparatus, subsequent to the method step of FIG. 36, according to an embodiment of the invention;

FIG. 38 illustrates an exemplary method step of use of the carriage apparatus, subsequent to the method step of FIG. 37, according to an embodiment of the invention;

FIG. 39 is a close-up, partial sectional view of the quick-release connector cooperation with a boat rail illustrated in FIG. 38;

FIG. 40 illustrates an exemplary method step of use of the carriage apparatus, subsequent to the method step of FIG. 38, according to an embodiment of the invention;

FIG. 41 illustrates an exemplary method step of use of the carriage apparatus, subsequent to the method step of FIG. 40, according to an embodiment of the invention;

FIG. 42 illustrates an exemplary method step of use of the carriage apparatus, subsequent to the method step of FIG. 41, according to an embodiment of the invention;

FIG. 43 illustrates an exemplary method step of use of the carriage apparatus with a grill, subsequent to the method step of FIG. 42, according to an embodiment of the invention;

FIG. 44 illustrates a rear perspective view of the FIG. 43 view;

FIG. 45 illustrates an exemplary method step of use of the carriage apparatus with the grill, subsequent to the method step of FIG. 42, according to an embodiment of the invention;

FIG. 46A is a perspective view of the quick-release connector of the carriage apparatus with the grill in cooperation with the boat rail;

FIG. 46B illustrates an exemplary method step of use of the carriage apparatus with the grill, subsequent to the method step of FIG. 42, according to an embodiment of the invention;

FIG. 46C illustrates an exemplary method step of use of the carriage apparatus with the grill, subsequent to the method step of FIG. 46B, according to an embodiment of the invention;

FIG. 46D illustrates an exemplary method step of use of the carriage apparatus with the grill, subsequent to the method step of FIG. 46C, according to an embodiment of the invention;

FIG. 46E illustrates an exemplary method step of use of the carriage apparatus with the grill, subsequent to the method step of FIG. 46D, according to an embodiment of the invention;

FIG. 47 is an action view of another quick-release connector of an exemplary carriage apparatus according to another embodiment of the invention;

FIG. 48 illustrates an exemplary method step of use of an exemplary carriage apparatus with the quick-release connector of FIG. 47 according to an embodiment of the invention;

FIG. 49 illustrates an exemplary method step of use of the carriage apparatus, subsequent to the method step of FIG. 48, according to an embodiment of the invention;

FIG. 50 illustrates an exemplary method step of use of the carriage apparatus, subsequent to the method step of FIG. 49, according to an embodiment of the invention; and

FIG. 51 illustrates an exemplary method step of use of the carriage apparatus, subsequent to the method step of FIG. 50, according to an embodiment of the invention.

### DETAILED DESCRIPTION OF THE PREFERRED EMBODIMENTS

This disclosure of the invention is submitted in furtherance of the constitutional purposes of the U.S. Patent Laws “to promote the progress of science and useful arts” (Article 1, Section 8).

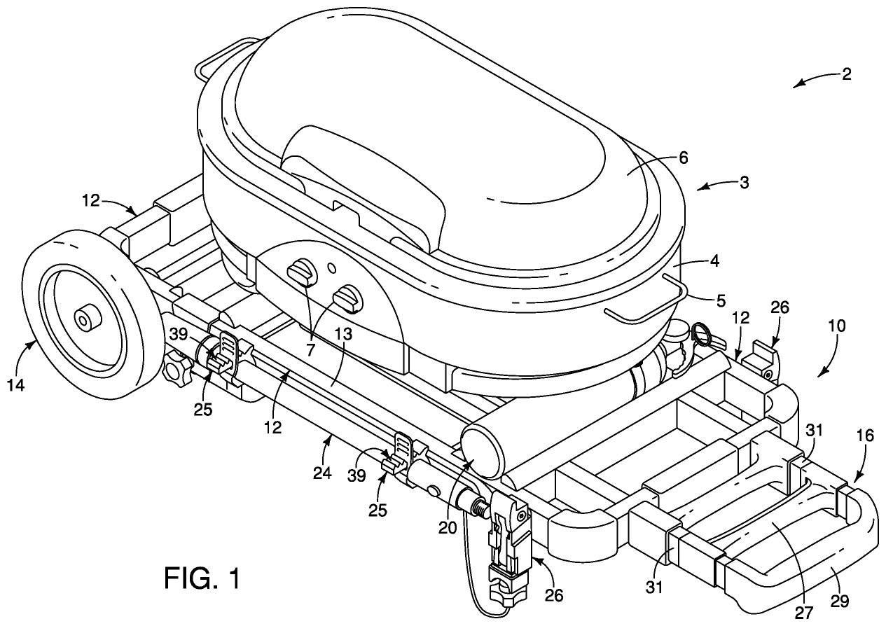

Referring to FIGS. 1-4, a carriage apparatus/grill 2 has an inventive carriage apparatus 10 supporting a grill 3 as illustrated according to an embodiment of the invention. It should be understood that any grill type or design can be configured for use with this inventive carriage apparatus 10. For simplicity, this document will illustrate and discuss one non-limiting type of grill, a portable grill, with an exemplary portable grill being a marine grill. An exemplary non-limiting grill 3 has a main body 4 with handles 5, a top or cover 6, and controls 7.

It should be understood that the carriage apparatus 10 is designed to provide multiple capabilities for grill 3, including but not limited to:
1) transporting the grill 3 effortlessly;
2) easily and simply securing the grill 3 to a marine vessel (boat);
3) providing as a support to stabilize the grill 3 during use, for example, grilling on a boat; and
4) effortlessly, easily and quickly removing the grill 3 from a boat upon a catastrophic event such as a grill fire.

Referring to FIG. 1, exemplary non-limiting components of the carriage apparatus 10 are discussed with the purposes, functions and structural aspects of these components being explained subsequently. Carriage apparatus 10 includes a frame 12, a pair of wheels 14 (other wheel shown in other Figs.) rotatably secured at one end, and to opposite sides, of the frame 12. A handle 16 is secured to at an opposite end of the frame 12. The carriage apparatus 10 further includes a fire extinguisher 20 releasably secured to the frame 12 between the grill 3 and handle 16. In one embodiment of carriage apparatus 10, the fire extinguisher 20 is in front of or forward of the grill 3 for easy and quick access in case of a catastrophic event such as a grill fire.

Still referring to FIG. 1, the carriage apparatus 10 includes a stabilizer bar or arm 24 releasably secured along one side 13 of frame 12. Furthermore, a pair of quick-release connectors (wing latches, butterfly latches, butterfly wing latches) 26 is secured to opposite sides of the frame 12 between the fire extinguisher 20 and the handle 16 (that is, at one end of frame 12). The quick-release connectors 26 will ultimately be used to secure the carriage apparatus 10 to a structure, such as a rail (gunnel rail) of a boat, in a quick-release fashion. An exemplary quick-release connector 26 is made of steel, for example stainless steel, and powder-coated in red for ease of location by eyesight during a stressful situation such as a grill fire.

Still referring to FIG. 1, an exemplary handle 16 includes a release cross bar 27, telescoping extensions 31, and grip 29. The telescoping extensions 31 are housed in the frame 12 in a sliding engagement and are routinely locked in one of various locations relative to the frame 12. The release cross bar 27 is biased away from the grip 29 and pulling the release cross bar 27 toward the grip 29 releases the handle 16 from a locked orientation. Freeing the release cross bar 27 from the pulling action returns the handle 16 to a locked orientation. After the handle 16 is released from a locked orientation, pulling on the grip 29 away from the frame 12 removes portions of the telescoping extensions 31 from the frame 12 to extend the handle 16 at a greater distance from the frame 12. Alternatively, after the handle 16 is released from a locked orientation, pushing on the grip 29 toward the frame 12 forces portions of the telescoping extensions 31 into the frame 12 to position the handle 16 at a closer distance to the frame 12. In this manner, the grip 29 can be positioned at a selective distance from the structure of frame 12.

Still referring to FIG. 1, the stabilizer bar 24 will ultimately be used to support and stabilize the carriage apparatus 10 on a boat with, or without, the grill 3. A pair of fastener or clasps 25 releasably secures the stabilizer arm 24 along side 13 of frame 12. In one embodiment, a non-limiting example of material for clasps 25 is rubber. An exemplary configuration for clasp 25 is a strip structure attached to side 13 of frame 12 and has a plurality of ridges 39 extending sequentially along one surface. Proximate one end of clasp 25 is an opening and an opposite end of clasp 25 extends through the opening wherein the ridges 39 selectively engages a periphery of the opening. Accordingly, the clasp 25 encircles the stabilizer bar 24 adjacent side 13 of frame 12. The greater the length of the end pulled through the opening of the clasp 25, the tighter the clasp 25 encircles the stabilizer bar 24, The purpose and function of the stabilizer bar 24 is discussed more thoroughly subsequently.

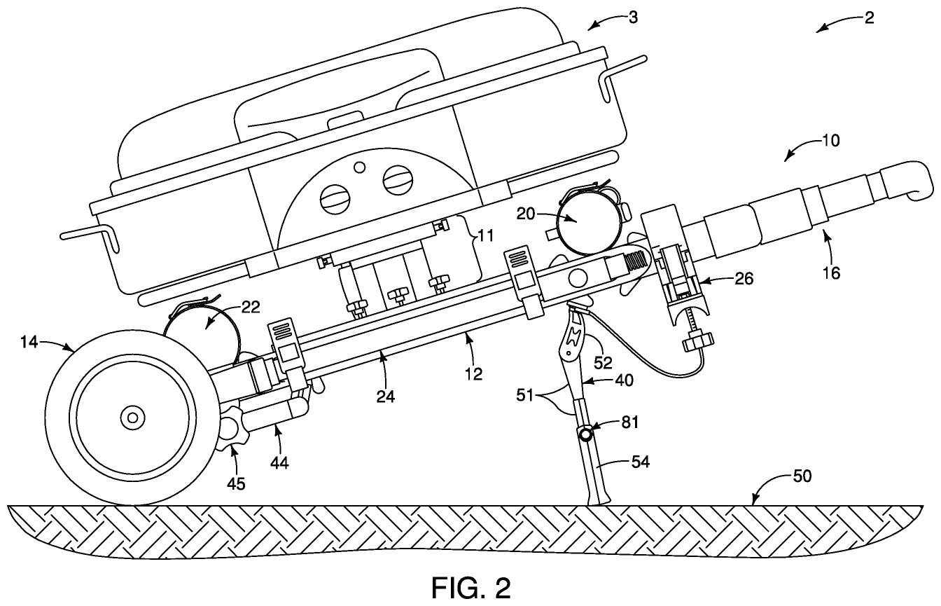

Referring to FIG. 2, the carriage apparatus 10 includes a stand 40 (stand device; frame stand) that is pivotably secured to the bottom of frame 12 and is configured to keep the handle 16 of frame 12 in a raised, upright position above a substrate 50 (ground, pavement, deck, etc.). This positioning of frame 12 facilitates engaging handle 16 with a hand. The stand 40 also prevents the carriage apparatus 10 from rolling down an incline. The stand 40 includes an upper arm 52 secured to frame 12 in a stationary position. A lower arm 51 is pivotably secured to the upper arm 52 and a foot 54 slidingly engages the lower arm 51. A engagement device 81 releases the foot 54 from a locked position on lower arm 51 and alternatively locks the foot 54 to a preselected position on the lower arm 51. In this figure, stand 40 is shown in an open (extended) position.

Still referring to FIG. 2, a mating/swivel device 11 (hereinafter, also referred to as a mating device) provides for selectively releasing, and securing, the grill 3 and carriage apparatus 10. The mating device 11 will be discussed more thoroughly subsequently. A canister 22 is releasably secured to the top of the frame 12 in front of the wheels 14. In one embodiment, a non-limiting example of the canister 22 is a fuel canister (spare fuel cannister) such as a propane cannister. A connecting bar 44 is pivotably secured to the bottom of the frame 12 in front of the wheels 14. A knob 45 tightens the connecting bar 44 is a specific position and releases the connecting bar 44 to allow pivot action of the connecting bar 44. The connecting bar 44 is ultimately secured to the stabilizer bar 24.

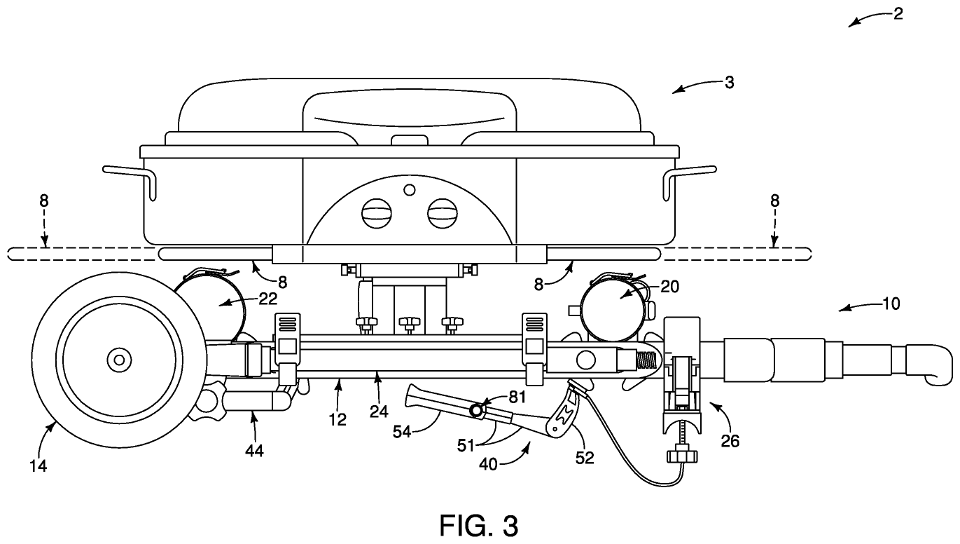

Referring to FIG. 3, an exemplary grill 3 includes a pair of platform trays (wings) 8 that selectively extend outwardly from beneath the main body 4 of grill 3 (extended position shown in phantom). The platform trays 8 provide surface area to receive utensils, plates, etc. during use of the grill 3. The stand 40 is shown in a closed position and resting locked with the lower arm 51 is under, and generally parallel with, the frame 12. Stand 40 can pivot between the open position of FIG. 2 and this closed position. In both closed and open positions, stand 40 is locked in the respective positions.

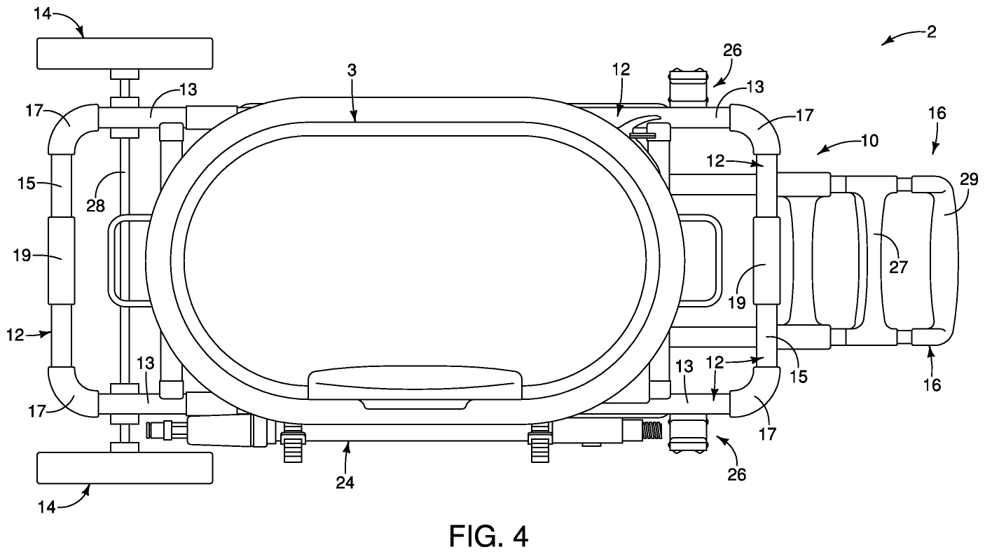

Referring to FIG. 4, frame 12 is shown as a tubular structure configured as a rectangle. The frame 12 has a pair of parallel sides 13 oriented to extend in the length direction of the rectangular configuration. Moreover, the frame 12 has a pair of parallel sides 15 oriented to extend in the width direction of the rectangular configuration and connect sides 13. In one embodiment, corners of the rectangular tubular frame 12 are curved (arcuate, rounded, bent). The curved corners of frame 12 are covered with a protective material or layer 17. An exemplary protective layer 17 is any thermoplastic material with one non-limiting example being polyethylene. Frame 12 has several cross-bar structures that extend in both directions along the length and width of frame 12 and will be discussed when needed.

Still referring to FIG. 4, an exemplary cross-sectional configuration of the tube configuration for frame 12 includes a hollow square. In other embodiments, any geometric configuration can be given for a cross-sectional configuration of frame 12 such as a hollow circle, hollow rectangle, and any hollow polygon such as an octagon, etc. The cross-sectional configuration of frame 12 can be solid instead of hollow. It should be understood that any other section or portion of the frame 12 can be covered with a protective material or layer similar to protective layer 17 at the corners of the frame 12. For example, portions of sections 15 are covered with a protective material referenced as layer 19. An exemplary protective layer 19 is any thermoplastic material with one non-limiting example being polyethylene. Protective material 19 can be different from, or the same as, protective material 17.

It should be understood that frame 12 can comprise various materials, for example metals and/or plastics, singularly or in any combination. An exemplary metal is aluminum and an exemplary plastic is any thermoplastic and/or fiber glass.

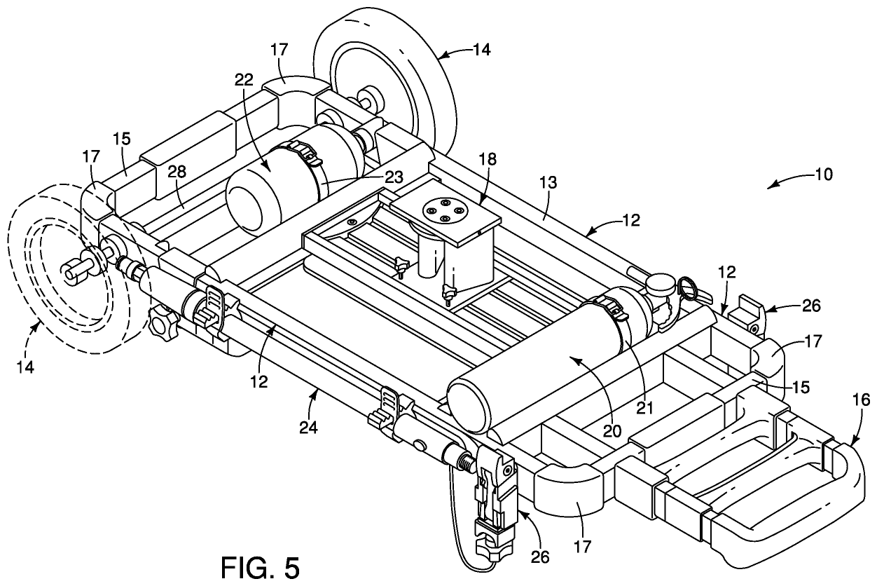

Referring to FIGS. 5-7, the carriage apparatus 10 is illustrated and described without grill 3 to more easily show and discuss inventive aspects of the carriage apparatus 10. Referring to FIG. 5, the pair of wheels 14 are shown with one in phantom to illustrate exemplary inner structure for the wheels 14. The wheels 14 are secured to opposite ends of an axle 28. In one embodiment, axle 28 is rotatably secured to frame 12 with wheels 14 stationary on opposite ends of axle 28. In another embodiment, axle 28 is stationary in frame 12 with wheels 14 rotatably secured to opposite ends of an axle 28. Exemplary wheels 14 include 8-inch wheels with a steel axle 28 with an aluminum sleeve.

Still referring to FIG. 5, the carriage apparatus 10 includes a male component (male connector, male swivel base) 18 of mating device 11 which is shown generally centrally located on top of frame 12 between extinguisher 20 and fuel cannister 22. The male connector 18 is configured to mate with a female component (connector) attached to grill 3 described and shown more thoroughly subsequently. The fire extinguisher 20 is releasably secured to the frame 12 by latch 21. The fuel cannister 22 is releasably secured to the frame 12 by latch 23.

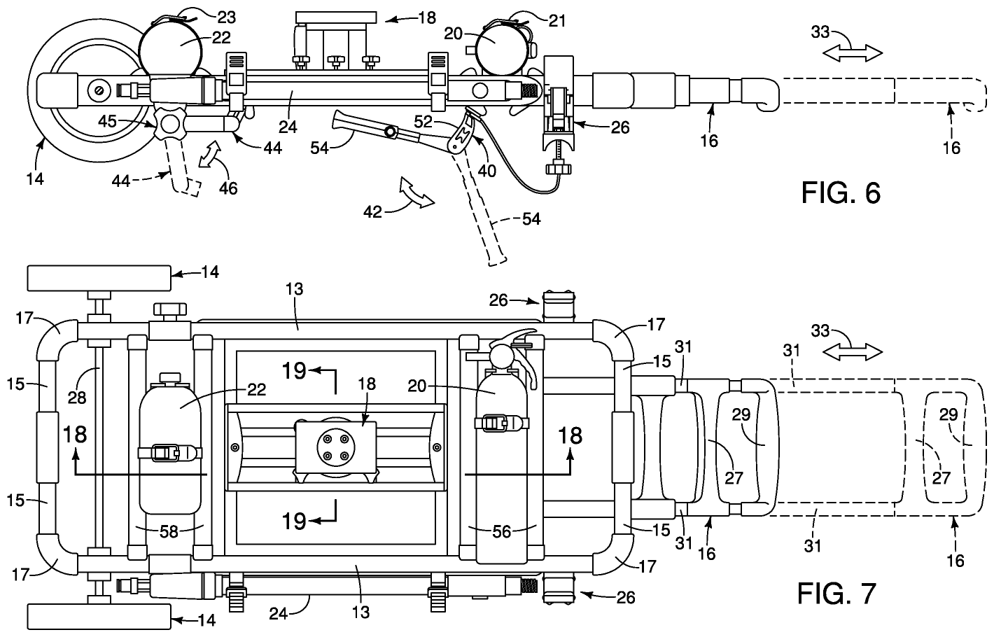

Referring to FIG. 6, the pivot action 42 of the stand 40 is shown with the closed position illustrated in solid lines and the open position illustrated in phantom. Moreover, the pivot action 46 of the connecting bar 44 is shown with the closed (folded) position illustrated in solid lines and the open position illustrated in phantom.

Referring to FIGS. 6 and 7, the telescoping (extending) action 33 of the handle 16 is shown with the closed position illustrated in solid lines and the open (extended) position illustrated in phantom.

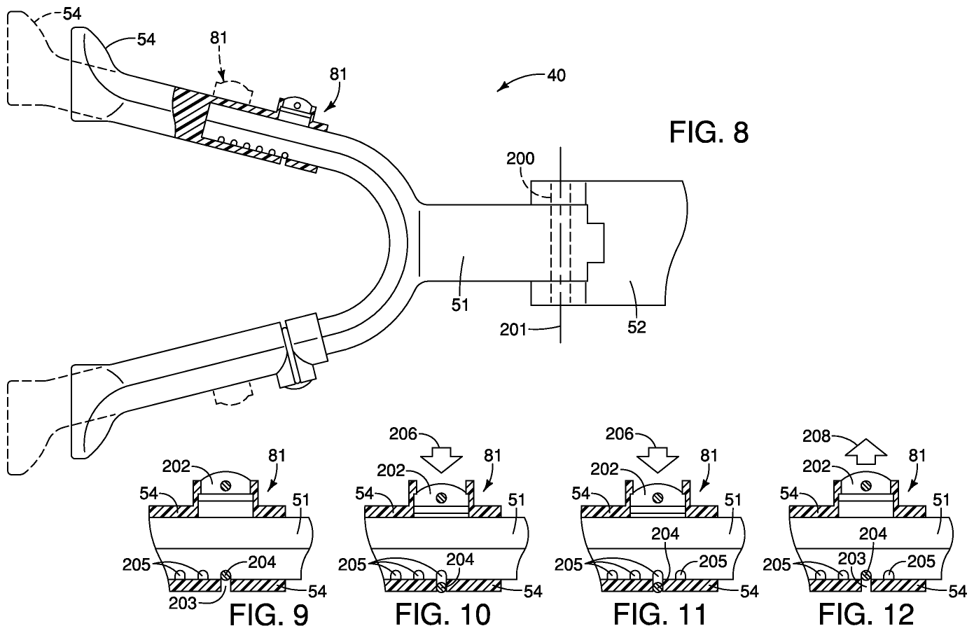

Referring to FIGS. 8-12, an exemplary operational configuration of the foot 54 slidingly engaging the lower arm 51 of stand 40 is shown and described. Referring to FIG. 8, an exemplary pivot axis 201 between the upper arm 52 and the lower arm 51 is shown and can be enacted by a linear bearing 200. Each foot 54 independently slidingly engages the lower arm 51, and in this embodiment, operate the same way so only one is referenced and described.

Referring to FIG. 9, engagement device 81 in foot 54 is shown in the rest position and includes a button 202. Button 202 is configured to activate an engagement prong 204 which is resting in one of a plurality of openings 205 in lower arm 51 aligned with an orifice 203 in foot 54. The plurality of openings 205 may be configured in other shapes such as slits or slots having a V shape. It should be understood that activating engagement prong 204 selectively moves the engagement prong 204 between the opening 205 in lower arm 51 and the orifice 203 in foot 54.

Referring to FIG. 10, in one embodiment, pressing the button 202 in direction 206, for example with a finger, toward the lower arm 51 drives the engagement prong 204 from the opening 205 in the lower arm 51 into the orifice 203 in foot 54. Foot 54 can now be slid (moved) along the lower arm 51 to be selectively aligned with another one of the plurality of openings 205 in lower arm 51.

Referring to FIG. 11, while the button 202 is continual pressed in direction 206, the engagement prong 204 remains in the orifice 203 of the foot 54 and the foot 54 is moved to align the engagement prong 204 with another one of the plurality of openings 205 in the lower arm 51.

Referring to FIG. 12, button 202 is released from being pressed and is biased (for example, by a spring not shown) in direction 208 allowing engagement prong 204 to enter the selected another one of the plurality of openings 205 in the lower arm 51. In this fashion, the foot 54 is positioned to rest in another location relative to the lower arm 51 allowing for the carriage apparatus 10 to be selectively lowered or raised relative to a substrate such as the ground.

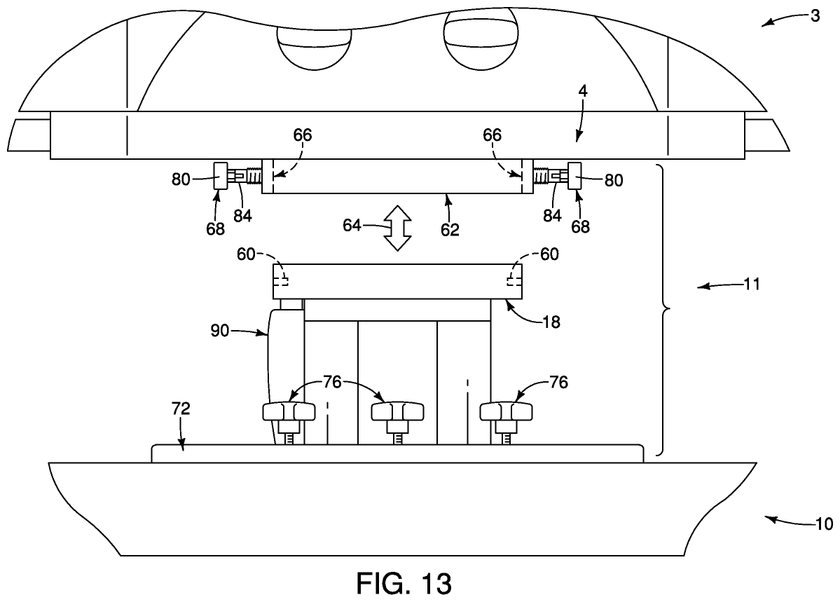

Referring to FIGS. 13-17, the mating/swivel device 11 is more thoroughly illustrated and described according to embodiments of the invention. The carriage apparatus 10 includes the male component 18 of the mating device 11 and the grill 3 includes the female component 62. FIG. 13 illustrates the mating/swivel device 11 in the separated or released position. The grill 3 and carriage apparatus 10 are reciprocally moved in direction 64 to selectively remove the grill 3 from the carriage apparatus 10, and alternatively, to selectively attach the grill 3 to the carriage apparatus 10. The female component 62 is secured to a bottom of the main body 4 of the grill 3. The female component 62 is configured as a receptacle having a cavity 66 (shown subsequently) that is dimensioned to receive the male component 18, and in one embodiment, in a tight fit. The female component 62 includes a pair of plungers ((plunger devices, plunger nuts, plunger pins) 68 on opposite sides of the female component 62. Each plunger 68 has a head portion 80 and a housing 84 enclosing an inner stem 87 extending from the head portion 80. The male component 18 includes a pair of apertures 60 in opposite sides of the male component 18. The apertures 60 are aligned and dimensioned to receive portions of the plungers 68. Referring to FIG. 13, a plurality of stays 76, a slide rail 72 and handle 90 of carriage apparatus 10 are described more thoroughly subsequently.

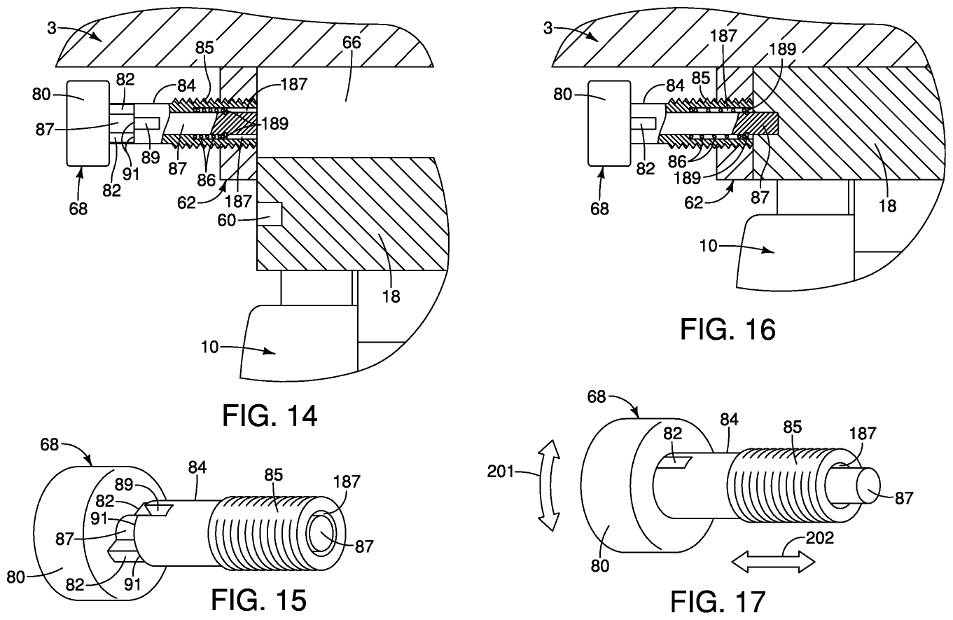

Referring to FIG. 14, the beginning method step of attaching grill 3 to carriage apparatus 10 is shown and described. The outer periphery of the male component 18 is of the carriage apparatus 10 is beginning to enter the cavity 66 of the female component 62 of grill 3. At this stage, referring to FIGS. 14 and 15, the plunger 68 is in an open position having no portion of the structure in cavity 66 which allows the male component 18 to slide into the female component 62 unencumbered. Threads 85 extend from, and surround, an outer periphery of the lower section of the housing 84 of plunger 68. The threads 85 are wound into a corresponding opening and threads in a side wall of the female component 62. The housing 84 of plunger 68 is a hollow structure having a cylindrical opening 187. Plunger 68 has an inner stem 87 extending from the head portion 80 into the cylindrical opening 187 of the housing 84. The inner stem 87 is has a greater length dimension than the housing 84 and is capable of sliding along the longitudinal axis (202, see FIG. 17) through the cylindrical opening 187 of the housing 84. Moreover, the inner stem 87 is capable of rotating or twisting about the longitudinal axis (201, see FIG. 17) in the cylindrical opening 187 of the housing 84.

Still referring to FIGS. 14 and 15, a biasing member in the plunger 68, such as a spring 86, biases the head portion 80 and the inner stem 87 longitudinally toward cavity 66. That is, a portion of the cylindrical opening 187 (toward cavity 66) of the housing 84 has a greater diameter than a diameter of the cylindrical opening 187 in the portion of the housing 84 proximate the head portion 80. Accordingly, one end of the spring 86 abuts against a shoulder (not referenced) of the smaller diameter of the cylindrical opening 187 and an opposite end of the spring 86 abuts against a washer 189 that encircles the inner stem 87. An inner periphery of the washer 189 is immovably secured the outer periphery of the inner stem 87 and extends partially into the cylindrical opening 187. As the inner stem 87 moves longitudinally through the cylindrical opening 187, the washer 189 moves longitudinally through the cylindrical opening 187 with the inner stem 87. Therefore, as the plunger 68 is pulled in the direction away from the cavity 66, the washer 189 compresses the spring 86 against the shoulder (not referenced) of the smaller diameter of the cylindrical opening 187 which increases the biasing (force) on the plunger 68 to move toward the cavity 66. Releasing the plunger 68 allows the spring 86 to bias the plunger 68 toward the

Still referring to FIGS. 14 and 15, at least one stop knob 82 extends from the head portion 80 and the inner stem 87. In one embodiment, a pair of stop knobs 82 extend from the head portion 80 and opposite sides of the inner stem 87. In the open position for plunger 68, the stop knob(s) 82 abutt against an upper shelf 91 of the housing 84 and are biased against the upper shelf 91 by spring 86. Note that in the open position, the inner stem 87 does not extend out of the housing 84 of plunger 68.

Referring to FIGS. 16 and 17, after the male component 18 of carriage apparatus 10 is provided completely into the cavity 66 of the female component 62 of the grill 3, the head portion 80 of plunger 68 is engaged by fingers and rotated as indicated by direction 201. The plunger 68 is rotated 201 until the stop knobs 82 are aligned over slots 89 (see FIGS. 14 and 15) in the upper section of the housing 84. Since the plunger 68 is biased toward the cavity 66, once the head portion 80 is released, the inner stem 87 moves longitudinally 202 with the stop knobs 82 moving into the slots 89. The head portion 80 will move to rest or abut against the upper shelf 91 (see FIGS. 14 and 15) and the bottom section of the inner stem 87 will extend out of housing 84 and enter the aperture 60 of the male component 18. In this fashion, the male component 18 is secured or retained in the cavity 66 of the female component 62 thereby securing or retaining the grill 3 to the carriage apparatus 10. It should be understood that this configuration of plunger 68 represents the closed position for plunger 68.

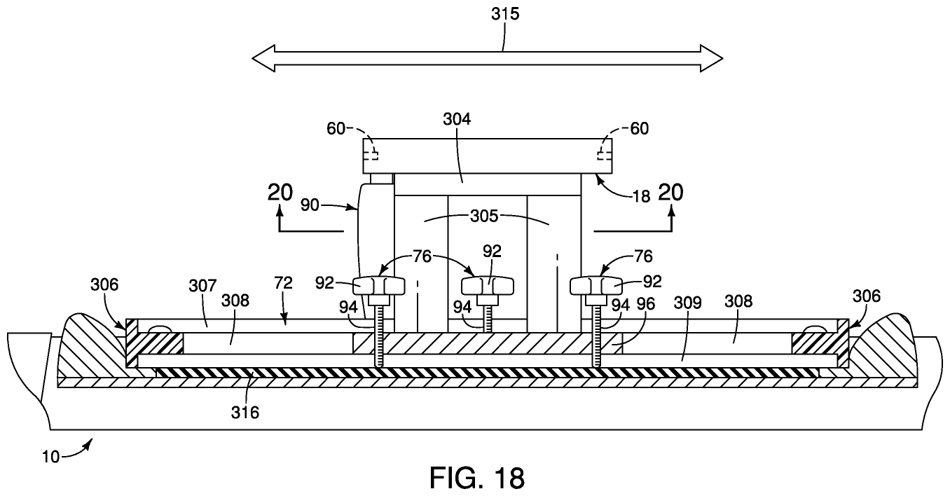

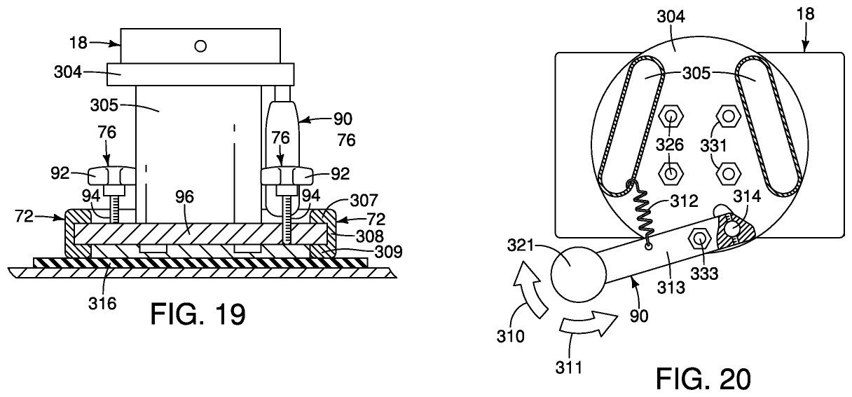

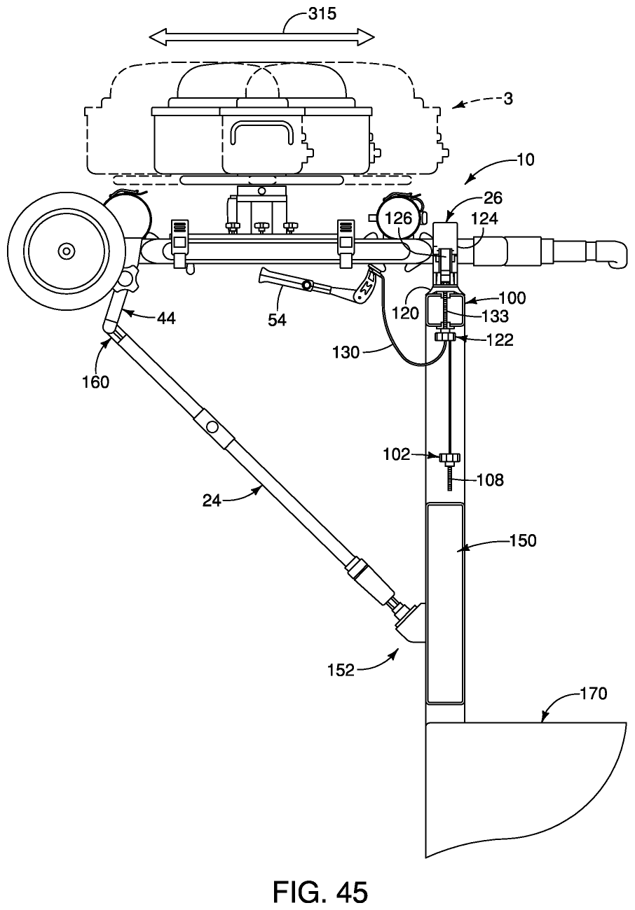

Referring to FIGS. 18-19 (see also FIG. 45), the sliding action of male component 18 is shown and described. The plurality of stays 76, the slide rail 72 and the handle 90 of carriage apparatus 10 have been mentioned previously. The male component 18 is supported upon a swivel support 304, the swivel support 304 is supported upon columns 305, columns 305 are supported on slide base 96, and slide base 96 is supported upon support plate 316. Each of the plurality of stays 76 includes a knob 92 on top of a threaded stem 94. The slide rail 72 includes a slide bearing (also termed race, or track or channel) 308 defined by an upper flange 307 and a lower flange 309. The threaded stems 94 of stays 76 are threaded through slide base 96 and terminate above, and selectively against, the support plate 316. In one embodiment of carriage apparatus 10, there are three stays 76, but less or more are contemplated.

Still referring to FIGS. 18-19, the slide base 96 is in sliding engagement with the slide bearing 308 which provides sliding movement for the male component 18 along reciprocal direction 315. The male component 18 can be positioned at any location along the length of the slide rail 72 between stops 306. Once a position for the location of male component 18 is selected, one or more of the plurality of stays 76 is tightened down on top of the support plate 316 to maintain the male component 18 in the selected position. To tighten any one stay 76, the knob 92 is rotated (twisted) driving the threaded stem 94 against the support plate 316. Correspondingly, to move the male component 18 again, any stay 76 that is in a tightened position must be loosened to allow the movement of the male component 18. That is, the knob 92 is rotated (twisted) in the opposite direction to lift the threaded stem 94 from being against the support plate 316.

Referring to FIG. 20, the bottom or underside of male component 18 and swivel support 304 is illustrated. The swivel support 304 is secured to male component 18 by a bolt 330 and nut 331 combination. Columns 305 are shown sectioned. Handle 90 includes a grip 321 and an arm 313 extending perpendicularly from the grip 321. The arm 313 is secured to the swivel support 304 by a pivot pin 333 and the end of arm 313 has an engagement pin 314. A biasing member, such as a spring 312, is secured to the column 305 and arm 313 to bias the handle 90 in a biased direction 310. Moreover, in operation and explained subsequently, the grip 321 is engaged with a hand or fingers to pivot the handle 90 in a release direction 311 opposite to the biased direction 310.

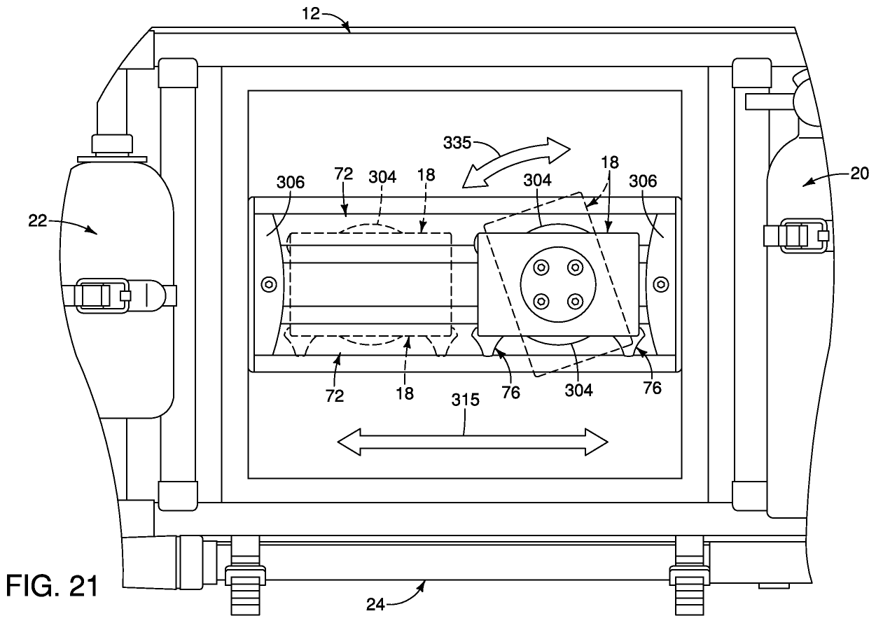

Referring to FIG. 21, the male component 18 is shown on carriage apparatus 10 and being capable of moving along the reciprocal direction 315. An exemplary sliding distance for the male component 18 can be considered as a range of infinitesimal increments. An exemplary range of sliding distances for the male component 18 is from about 3 inches to about 18 inches. In one embodiment, the sliding distance for the male component 18 is about 6 inches. It should be understood that with the grill 3 coupled to the male component 18, the grill 3 has the capability to move incrementally in any range as provided by the male component 18, for example, from about 3 inches to about 18 inches. This capability adds significant convenience to accommodate different lengths of arms of people performing the grilling.

Still referring to FIG. 21, the male component 18 is capable of rotating in a reciprocal rotation direction 335 about an imaginary pivot axis extending perpendicularly through a center of the male component 18. It should be understood that the male component 18 can be rotated in rotation direction 335 in a complete circle, that is, 360 degrees. It should be further understood that the male component 18 is rotated in selected increments of 360 degrees and then locked in place described subsequently. In one embodiment, the male component 18 is rotated and locked in increments of 45 degrees. In other embodiments, the male component 18 is rotated and locked in increments of less than, or more than, 45 degrees. Since the male component 18 is capable of rotation and sliding actions, logically, when the grill 3 is secured to the male component 18, the grill 3 is capable of the rotation and sliding actions.

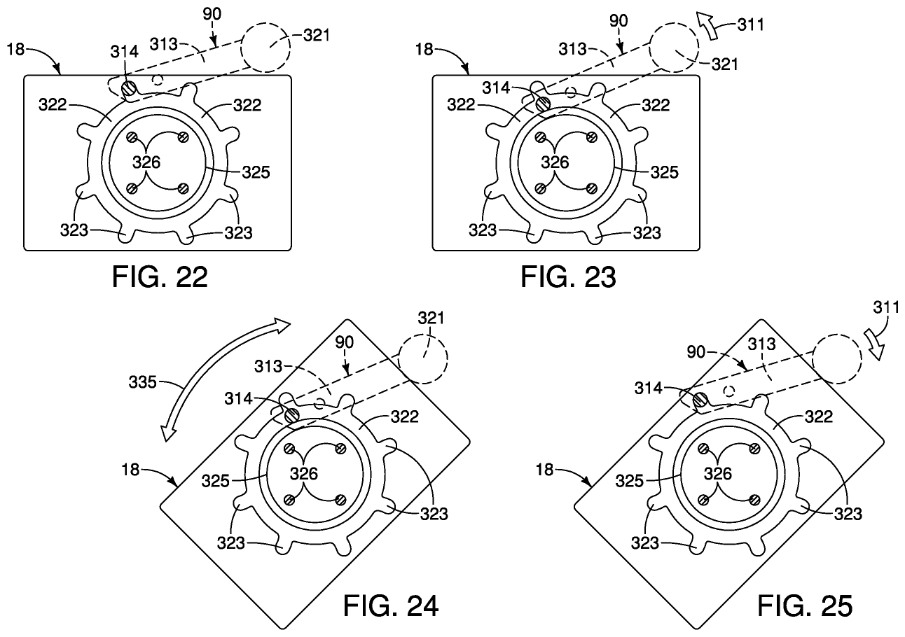

Referring to FIGS. 22-25, an exemplary configuration and operation of the male component 18 is described. It should be understood that other exemplary configurations and operations of the male component 18 can be described to perform the rotation and locking actions. A circular track 322 is carved into the lower surface of the male component 18. A plurality of locking grooves 323 extend outwardly from the outer periphery of the circular track 322 at spaced increments around the perimeter of the circular track 322. A circular ridge 325 forms the inner periphery of circular track 322. The engagement pin 314 of handle 90 selectively rides in the circular track 322 and the locking grooves 323.

Referring to FIG. 22, the male component 18 is in the locked orientation. In this orientation, the engagement pin 314 of handle 90 is biased, and therefore locked, in one of the locking grooves 323. In this locked orientation, the male component 18 is in a locked position, and if the grill 3 is secured to the male component 18, logically, the grill 3 is in the locked orientation.

Referring to FIG. 23, the grip 321 of handle 90 is engaged and pivoted in the release direction 311 to move the engagement pin 314 from the locking grooves 323 into the circular track 322.

Referring to FIG. 24, while the engagement pin 314 of handle 90 remains in the circular track 322, the male component 18 is rotated in rotation direction 335 until the male component 18 reaches a selected position. During this rotation of male component 18, the circular track 322 moves with the engagement pin 314 therein.

Referring to FIG. 25, once the male component 18 reaches the selected position, the grip 321 of handle 90 is released to allow the spring 312 to bias the engagement pin 314 from the circular track 322 into the most proximate locking groove 323. In this fashion, the male component 18 in locked in the selected position. Moreover, if the grill 3 is secured on the male component 18, then logically, the grill 3 is locked in the selected position. In this fashion, the grill 3 can be angled at different angles relative to the carriage apparatus 10 and to any structure on which the carriage apparatus 10 is secured.

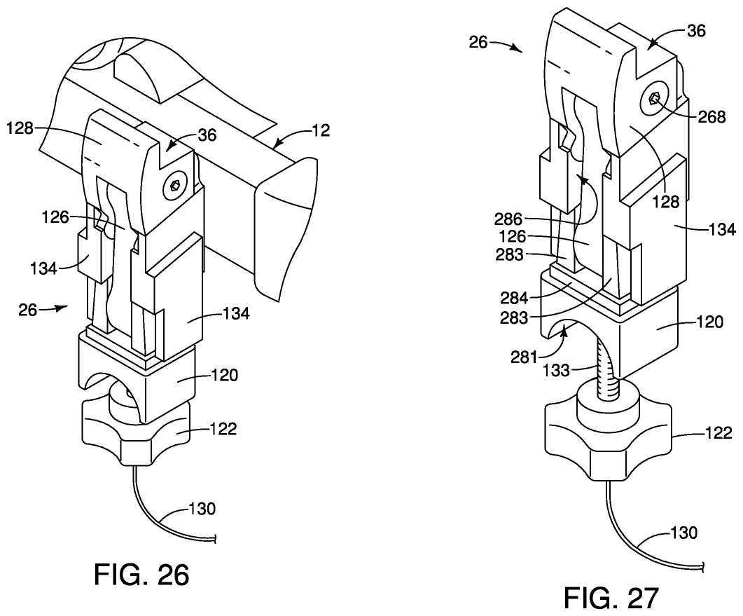

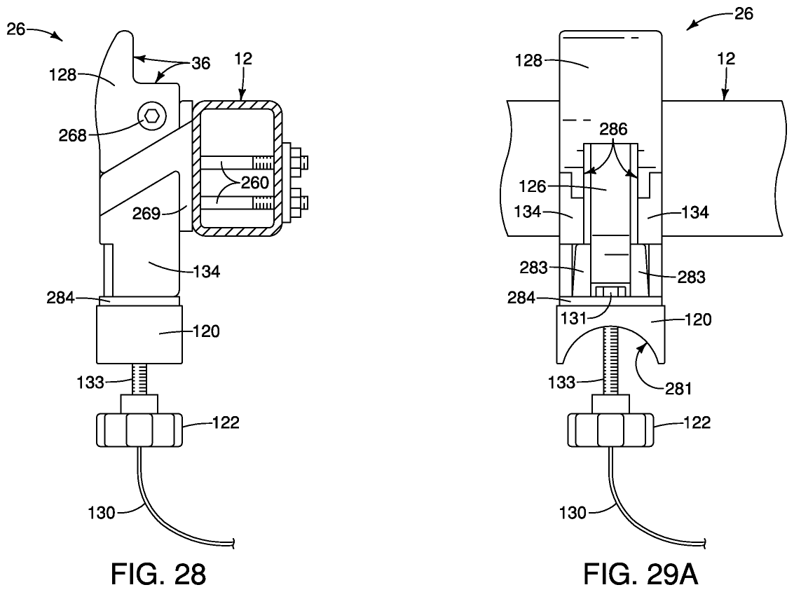

Referring to FIGS. 26-29A, a quick-release connector 26 of the pair is discussed more thoroughly including the purpose and function of same. The quick-release connector 26 has a centrally located main body or stationary body 134 that is secured to the frame 12 of carriage apparatus 10. In one embodiment (see FIG. 28), a securement plate 269 is between the stationary body 134 and frame 12 of carriage apparatus 10. A pair of bolt/nut 260 combinations secure the securement plate 269 and stationary body 134 to the frame 12 of carriage apparatus 10. On top of the stationary body 134 is an engagement body (or wing head) 128 biased against the main body 134 under pressure. An inside surface 36 facing frame 12 of the engagement body 128 is configured in an “L” shape to facilitate engagement by a hand and/or fingers, and particularly thumbs. A pivot pin 268 extends through the engagement body 128 generally parallel with the frame 12 and has only one end exposed in FIGS. 27-28.

Still referring to FIGS. 26-29A, the quick-release connector 26 includes an elastic connector or member 126 that provides the biasing action between the engagement body 128 and stationary body 134. The elastic connector 126 is an elongated structure of elastic material having a loop or eyelet at opposite ends. One eyelet end is received on the pivot pin 268 of in the engagement body 128. An exemplary elastic material for elastic connector 126 is an elastomer which is a class of polymer materials with high elastic nature and they include: natural rubber, synthetic rubber, nitrile rubber, silicone rubber, urethane rubbers, chloroprene rubber, Ethylene Vinyl Acetate (EVA rubber), etc. The elastic connector 126 is received in a central cavity (crevice) 286 in the main body 134 and the engagement body 128.

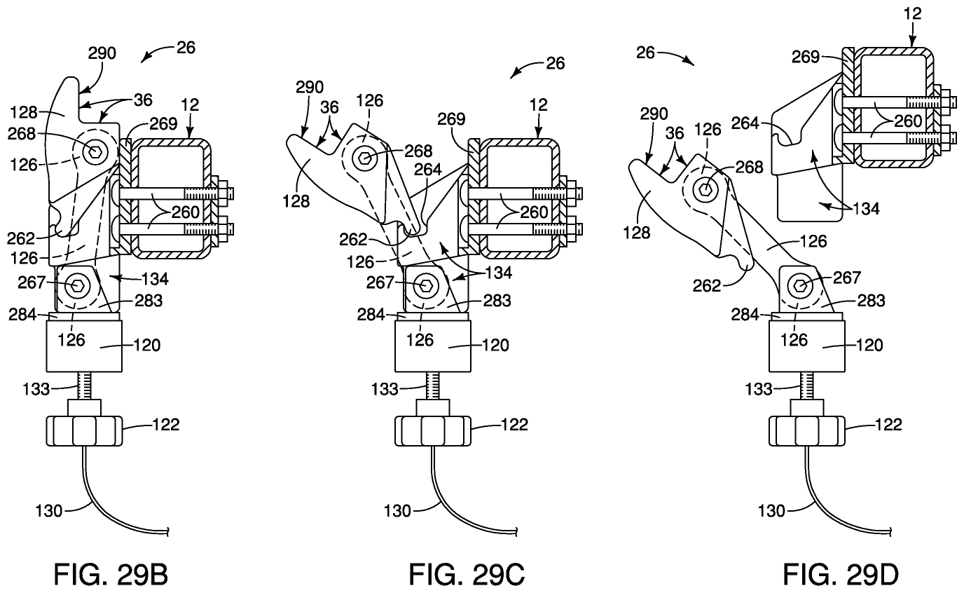

Still referring to FIGS. 26-29A, the quick-release connector 26 includes a pressure block composed of several components and that is biased against a bottom portion of the main body 134 by the elastic connector 126. The pressure block has a planar thin base 284 and two pivot plates 283 extending perpendicularly upward from the top of base 284. The pivot plates 283 are in a spaced relation relative to each other. A pivot pin 267 (see FIGS. 29B-29D) secures an end of the of the elastic connector 126, opposite to the end in the engagement body 128, to the pressure block between the pivot plates 283. Extending from the bottom of the base 284 is a pressure bushing or bearing (gasket, rubber gasket) 120. The bottom surface of the pressure bearing 120 is configured as a curved or arcuate seat 281 to be received on structures in a pressure relation such as a rail of a boat. An exemplary material for pressure bushing 120 is rubber which will protect the rail of the boat from scarring when the carriage apparatus 10 is secured to a rail of a boat. Moreover, the pressure bushing 120 reduces vibration (chatter) between the metal carriage apparatus 10 and the metal rail of the boat.

Still referring to FIGS. 26-29A, the elastic connector 126 biases the engagement body 128 against the top of the stationary body 134 and biases the pressure block, particularly the base 284, against the bottom of the stationary body 134. Since both the engagement body 128 and the pressure block (collectively the base 284, pivot plates 283 and seat 281) are on pivot pins 268 and 267, respectively, each has the capability to pivot or rotate about the ends of the elastic connector 126.

Still referring to FIGS. 26-29A, the quick-release connector 26 includes a threaded shank 133 extending through the pressure bearing 120 and through the base 284. The shank 133 has a head 131 at one end supported upon the top of base 283 below the elastic connector 126 and between the pivot plates 283. In one embodiment, the head 131 will rest upon the base 283 and in an alternative embodiment the head 131 is secured to the top of the base 283. Threaded onto an end of the shank 133 opposite to the end with the head 131 is a knob 122. The knob 122 is capable of being threaded on the shank 133. A cable 130 is attached to a bottom portion of the knob 122 and to the frame 12 of the carriage apparatus 10 (not shown here) with the purpose of not losing the knob 122 when not threaded on the shank 133.

In summary, the quick-release connector 26 can be described in more simple terms collectively as: a support structure (the stationary body 134) secured to the frame 12; a release device (collectively engagement body 128, pivot plates 283, base 284, knob 122, shank 133, pressure bearing 120) supported upon the support structure; and an elastic member (the elastic connector 126) biasing the release device against the support structure.

It should be understood that cable 130 can be secured or attached to any structural portion of frame 12 of the carriage apparatus 10. Still further, it should be understood that an exemplary cable 130 is configured to be easily broken under pressure, for example, a bead chain. An exemplary bead chain is a pull chain.

Referring to FIGS. 29B-29D, the operation of the quick-release connector 26 is described. In these views of FIGS. 29B-29D, an outer wall of the stationary body 134 is removed to discuss the inner structural configurations of the quick-release connector 26. A lower portion of the engagement body 128 extends a pivot ridge 262. The pivot ridge 262 is received in a pivot seat 264 formed in an inner edge in the stationary body 134. The pivot ridge 262 and the pivot seat 264 are correspondingly configured for a pivoting relationship between the stationary body 134 and the engagement body 128. Referring to FIG. 29B, a force 290 is applied to the inside surface 36 of the engagement body 128.

Referring to FIG. 29C, once the force 290 is increased to a magnitude to overcome the biasing action of the elastic connector 126, the engagement body 128 will begin to pivot about the pivot ridge 262 away from the stationary body 134 and away from the frame 12 of the carriage apparatus 10. There may also be a rotation of the engagement body 128 about pivot pin 268.

Referring to FIG. 29D, as the engagement body 128 pivots away from the stationary body 134, the elastic connector 126 pivots about the pivot pin 267 and the engagement body 128 is ultimately released from the stationary body 134 including the frame 12 and carriage apparatus 10. Additionally, the other components of the quick-release connector 26 are released from the stationary body 134, frame 12 and carriage apparatus 10. That is, the elastic connector 126, the pressure block (collectively the base 284, pivot plates 283 and seat 281), threaded shanks 133 and knob 122 are released from the stationary body 134, frame 12 and carriage apparatus 10.

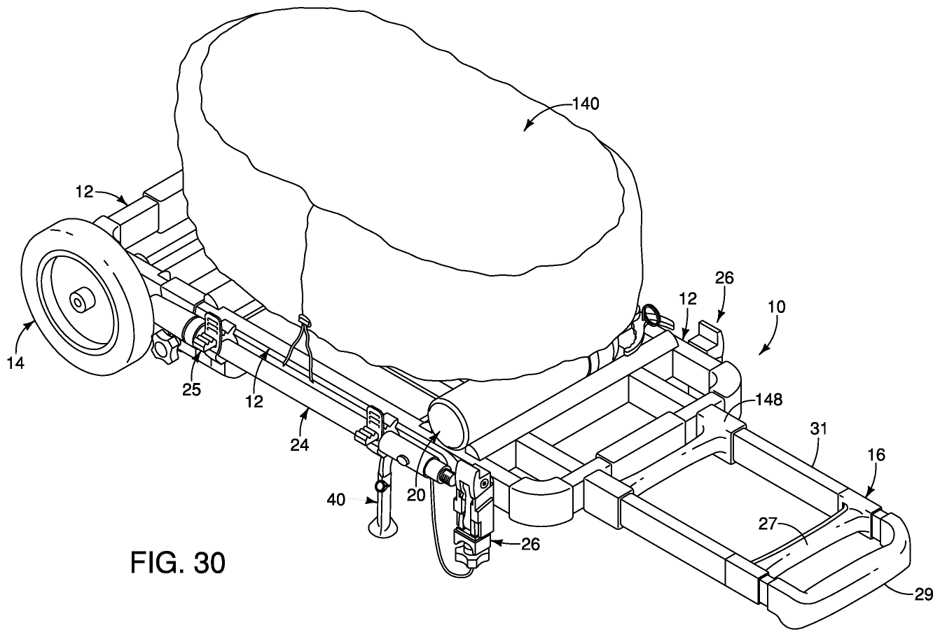

Referring to FIGS. 30-46, exemplary method steps for using the carriage apparatus 10 and grill are illustrated. Referring to FIG. 30, the carriage apparatus 10 is shown with a grill secured thereon and an optional cover 140 over the grill (It should be understood that an exemplary cover 140 can be comprised of various materials such as cloth and/or leather). The carriage 10 is resting and supported upon stand 49 over a substrate (not shown) such as pavement, floor or ground. It should be understood that the carriage apparatus 10 and grill can originally be transported in a vehicle. Then either together or separately, the carriage apparatus 10 and grill can be removed from the vehicle and set up on the ground or pavement. The handle 16 is in the open or extended position from the frame 12 for gripping to begin transport of the grill. The grill is easily transported via the carriage apparatus 10 to any location desired such as a dock proximate a boat. That is, by pulling on the handle 16, the grill and carriage apparatus 10 are driven along the substrate on wheels 14 of frame 12. The stand 40 can be provided in the closed or folded position before moving the carriage apparatus 10. Alternatively, the stand 40 can be left in the extended or open position during the transport of the carriage apparatus 10 and grill.

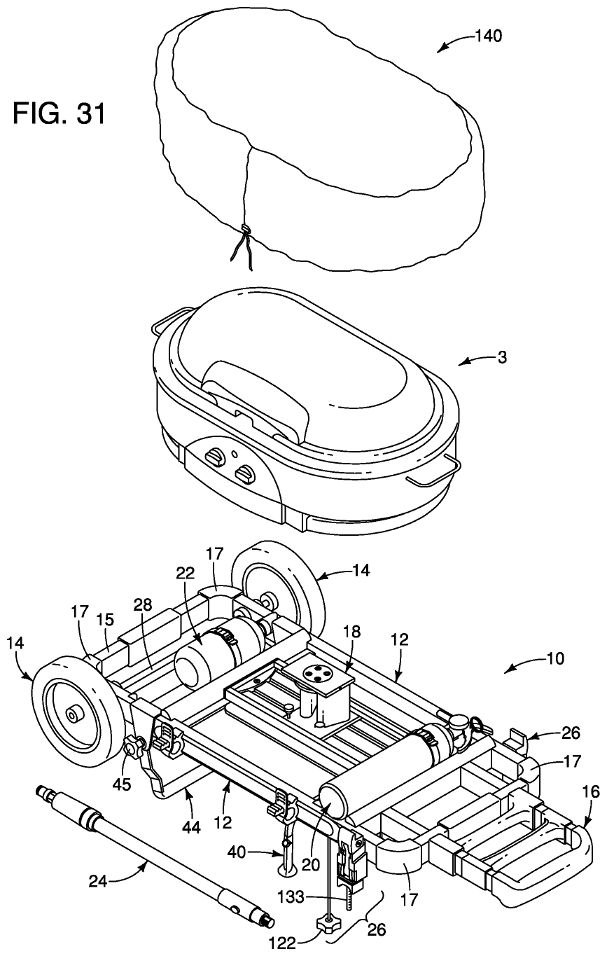

Referring to FIG. 31, once the desired location is reached, the carriage apparatus 10 can be “parked” in the raised resting position supported upon the stand 40 over a substrate such as a deck. The handle 16 can be positioned in the closed or retracted position for ease of continuing the setup of grill 3. If the grill 3 has the optional cover 140, the cover 140 is removed from the grill 3. To remove the grill 3, the pair of plungers 68 of the male component 18 are pulled and twisted as discussed previously to release the female component 62 and grill 3 from the carriage apparatus 10. The grill 3 and optional cover 140 are set aside. Moreover, the stabilizer bar 24 is removed from frame 12 and also set aside. The knobs 122 (only one shown) of the quick-release connectors 26 are removed from the pair of threaded shanks 133 (only one shown). Optionally, if the connecting bar 44 is in the folded (closed) position and locked, it can be unlocked and pivoted away from frame 12 to the connection (open) position by turning knobs 45 and then turned to tighten and lock the connection bar 44 in the open position.

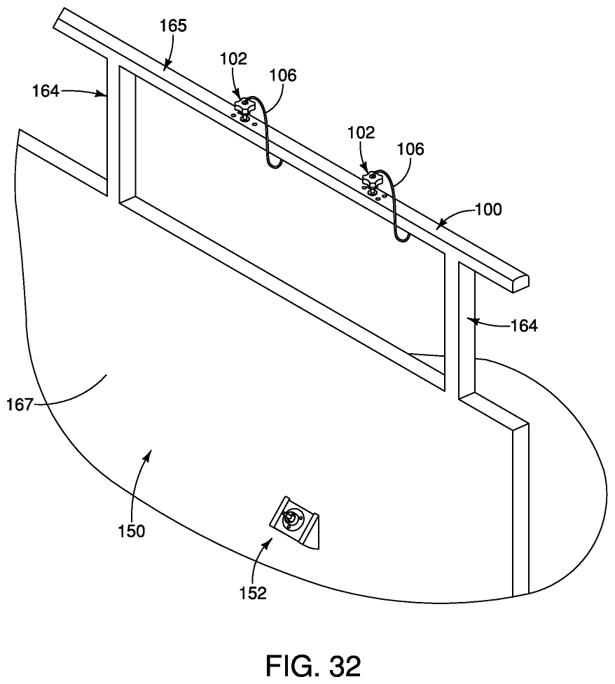

Referring to FIGS. 32-35, portions of an exemplary boat is illustrated and described that is to receive the grill 3 and carriage apparatus 10. Referring to FIG. 32, a portion of a wall 150 of an exemplary house boat is shown. An outer side surface 167 of wall 150 includes a male connector 152 extending outwardly. The male connector 152 is configured to receive a female connector of the stabilizer bar 24. Supported upon a top edge of the wall 150 is a rail 100, for example a gunnel rail, having a pair of vertical sections 164 supporting a horizontal section 165. A pair of openings in the horizontal section 165 of rail 100 receive protective bolts 102. Retaining cables 106 secure the protective bolts 102 to the horizontal section 165 of rail 100 to prevent loss of the protective bolts 102 when removed from the openings.

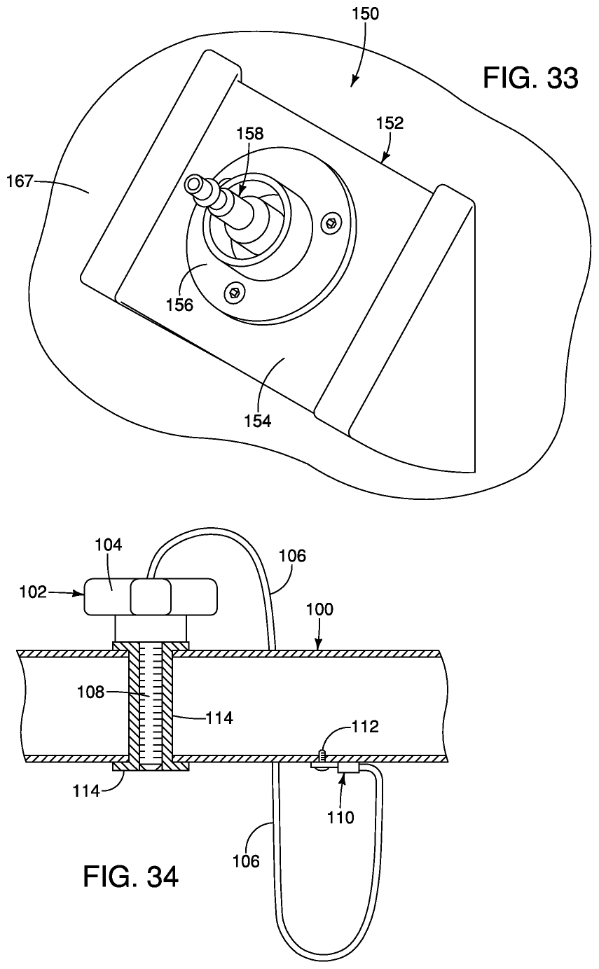

Referring to FIG. 33, the male connector 152 is more thoroughly illustrated and described. An angled surface 154 extends from the outer side surface 167 of the wall 150 to facilitate access of the male connector 152. The male connector 152 includes a base 156 and a nipple 158 extending outwardly from the base 156.

Referring to FIG. 34, one of the protective bolts 102 in respective openings of rail 100 is more thoroughly described. A bushing 114 is provided in each of the openings through rail 100 to strengthen and protect the opening. The bushings 114 establish openings to receive protective bolts 102. An exemplary protective bolt 102 has a knob 104 and a shank 108 extending from the knob 104. The shank 108 of protective bolts 102 is provided in the openings of the bushings 114 for protection of the openings. In one embodiment, the shank 108 and bushings 114 have corresponding threads for threading engagement. Alternatively, there are no threads. The retaining cable 106 is attached to the rail 100 by a clasp 110 and bolt 112. An exemplary bushing 114 comprises either a thermoplastic material or a metal material such as brass, steel and/or aluminum.

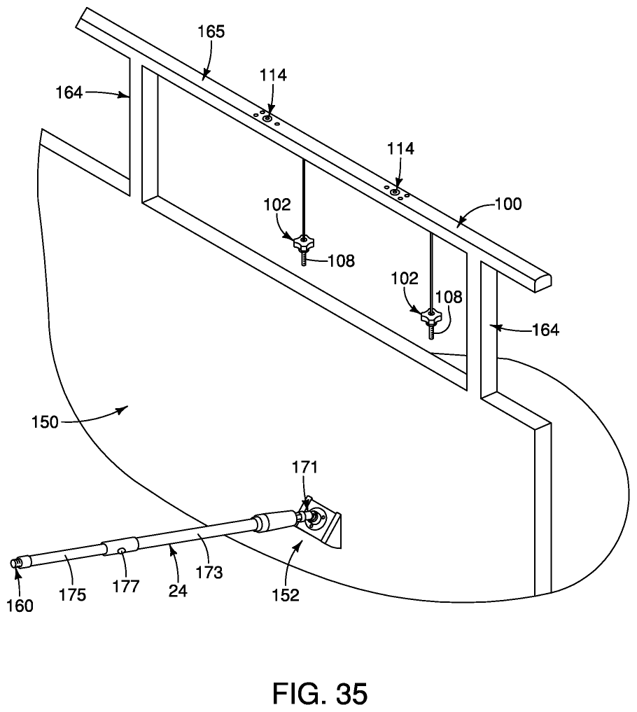

Referring to FIG. 35, the protective bolts 102 are removed from the respective openings of the bushings 114. At this time, the stabilizer bar 24 may be secured to the male connector 152. The stabilizer bar 24 is a linear structure with the female connector 171 at one end and a threaded portion 160 at the opposite end. The female connector 171 is configured to be received on the nipple 158 of the male connector 152 by a simple pressing force applied linearly along the stabilizer bar 24. The stabilizer bar 24 further includes a housing 173, a telescoping portion 175, and a release/lock button 177. By pressing the release/lock button 177, the telescoping portion 175 can be selectively extended and retracted relative the housing 173 to increase or decrease the length of the stabilizer bar 24 as needed. The stabilizer bar 24 is shown with the female connector 171 secured to the nipple 158 of the male connector 152.

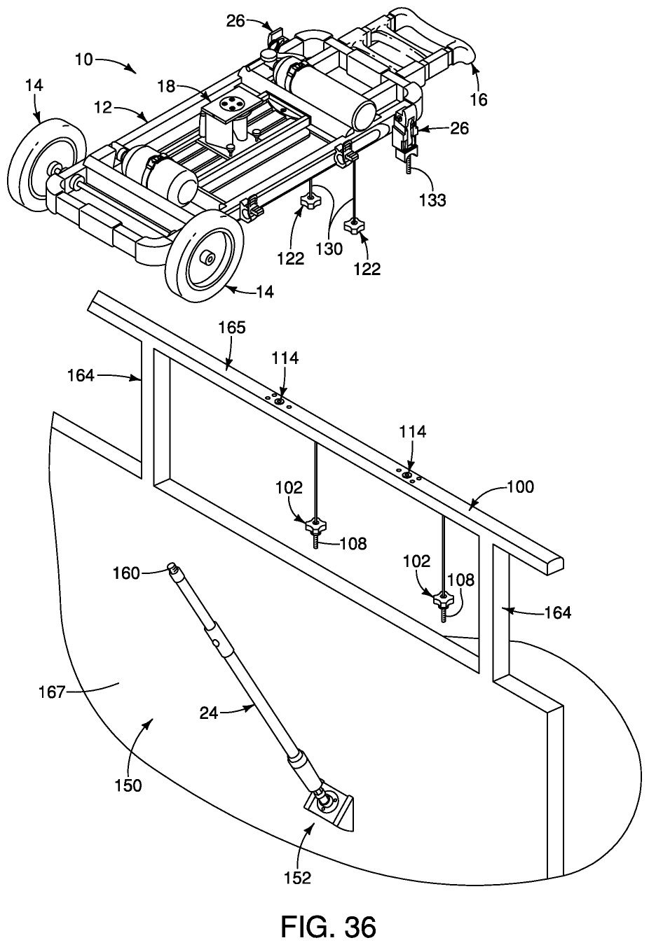

Referring to FIG. 36, the carriage apparatus 10 is lifted and positioned over rail 100 to align the threaded shanks 133 over the openings in the bushings 114 of rail 100. The telescoping portion 175 of the stabilizer bar 24 is selectively adjusted if needed.

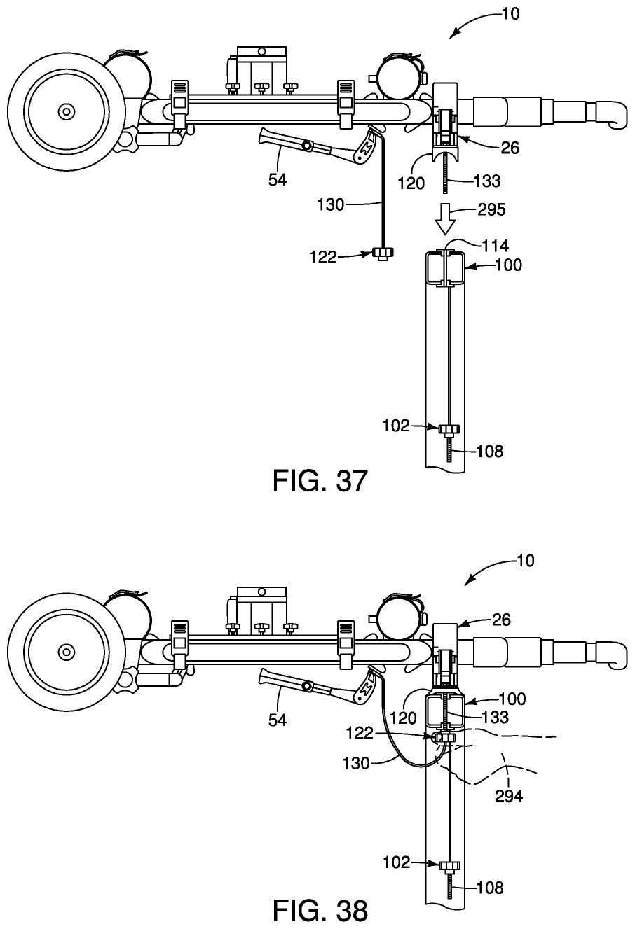

Referring to FIG. 37, the carriage apparatus 10 is lowered in direction 295 to move the threaded shanks 133 of the quick-release connectors 26 toward the openings in bushings 114 of rail 100.

Referring to FIG. 38, the threaded shanks 133 of the quick-release connectors 26 are positioned in the bushings 114 of rail 100 and the pressure bearing 120 is pressed against the rail 100 to cushion the securement of the carriage apparatus 10 upon the rail 100 and boat. The knobs 122 are threaded onto the threaded shanks 133 of respective quick-release connectors 26 by hand 294 and tightened to adequately secure the quick-release connectors 26, and therefore the carriage apparatus 10, to rail 100 and the boat.

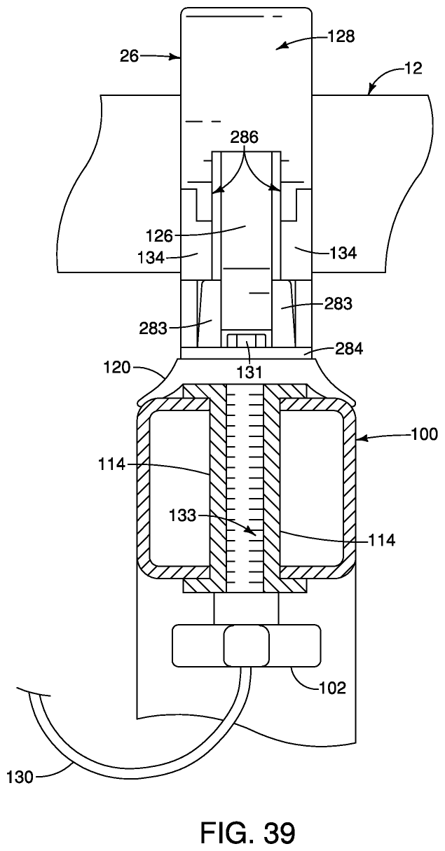

Referring to FIG. 39, the threaded shanks 133 in the bushings 114 of rail 100 is more readily shown. As knobs 122 are tightened on shanks 133, an upper portion of the knobs 122 are pressed against a lower portion of bushings 114. Moreover, as stated previously, the pressure bearing 120 is pressed and flattened against the bushings 114 and the rail 100 to cushion the securement of the frame 12 of carriage apparatus 10 upon the boat.

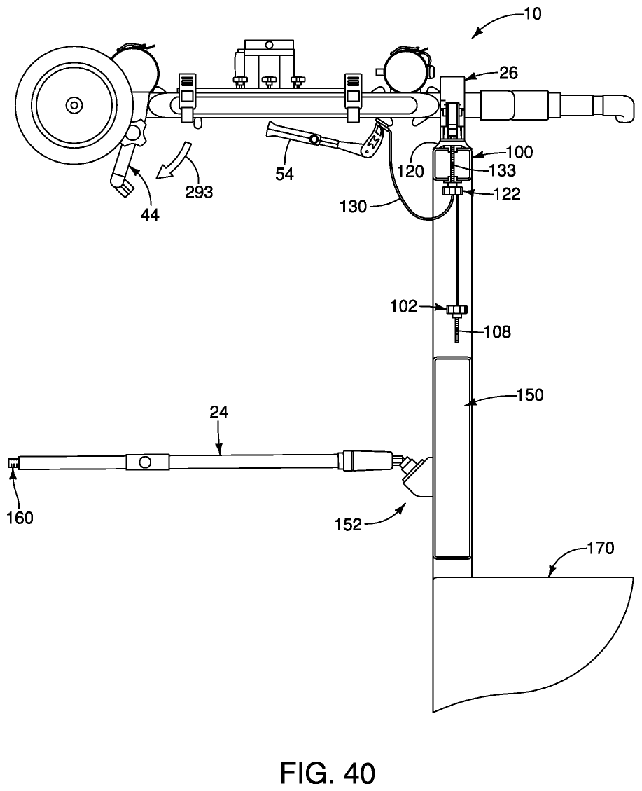

Referring to FIG. 40, the quick-release connectors 26 have secured the carriage apparatus 10 to rail 100. In this view, a bottom surface of the boat such as a floor 170 is illustrated. The connecting bar 44 is pivoted in direction 293 to position the connecting bar 44 from the closed (folded) position to the open (unfolded) position illustrated. In this position, the connecting bar 44 and the stabilizer bar 24 are ready to be secured together.

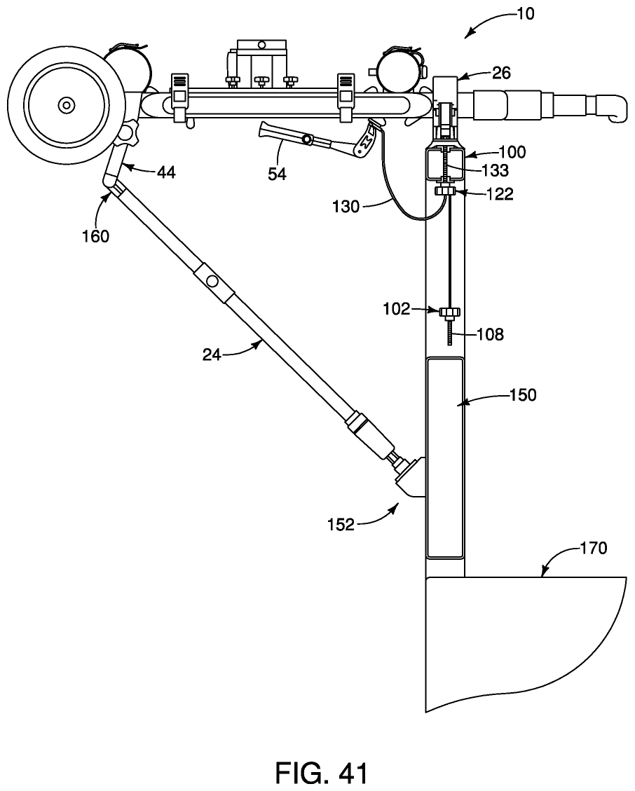

Referring to FIG. 41, the threaded portion 160 of the stabilizer bar 24 is threaded into the connecting bar 44 thereby stabilizing the carriage apparatus 10 on rail 100 of the boat.

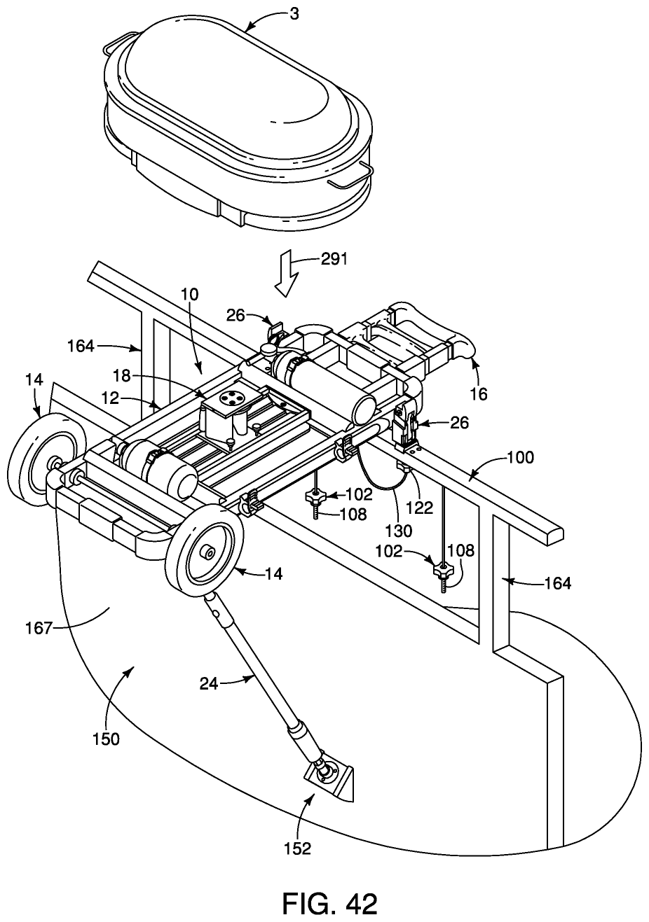

Referring to FIG. 42, grill 3 is positioned above the carriage apparatus 10 for securing the grill 3 to the carriage apparatus 10. Grill 3 is moved in direction 291 to provide the cavity 66 of the female component 62 over the male component 18 of the carriage apparatus 10. The pair of plungers 68 on opposite sides of the female component 62 are turned until the portions of the plungers 68 move into the apertures 60 in opposite sides of the male component 18. The grill 3 is now secured to the carriage apparatus 10.

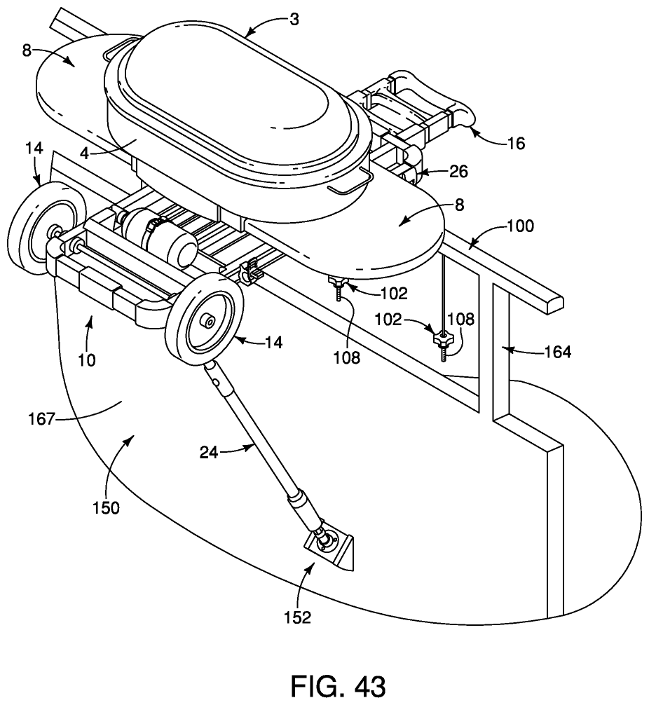

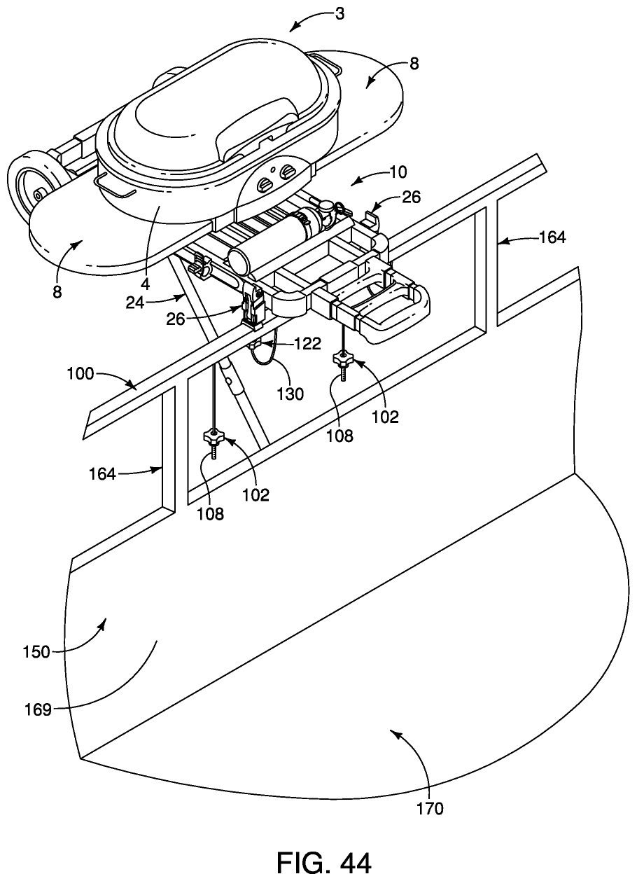

Referring to FIGS. 43 and 44, different perspectives of using the grill 3 is shown with the pair of platform trays (wings) 8 selectively extending outwardly from beneath the main body 4 to receive utensils, plates, etc. during the grilling. In FIG. 44, an inner side surface 169 of wall 150 is shown.

Referring to FIG. 45, the grill 3 is shown being capable of being moved in the reciprocal direction 315 by the sliding action of the male component 18 previously described. This capability allows for comfort of people with different arm lengths to perform the grilling.

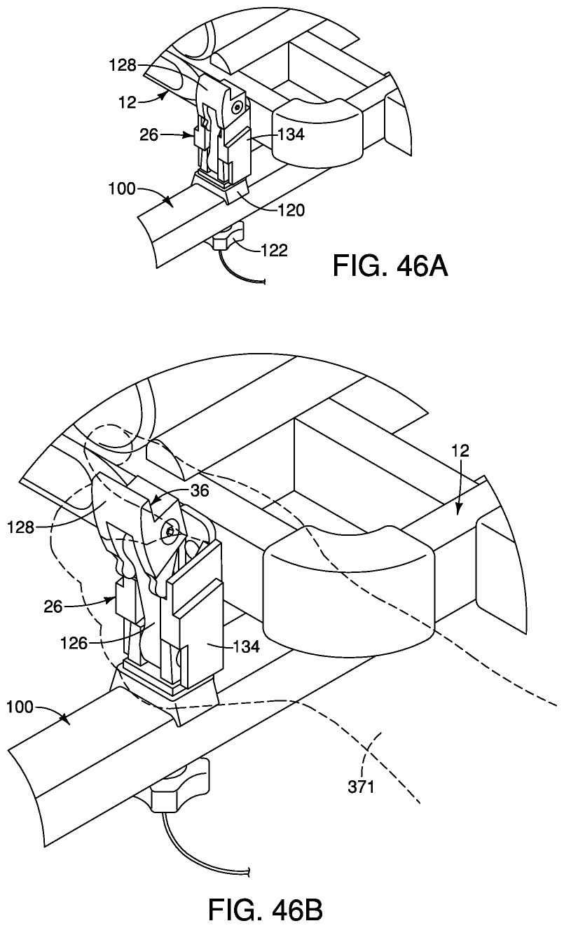

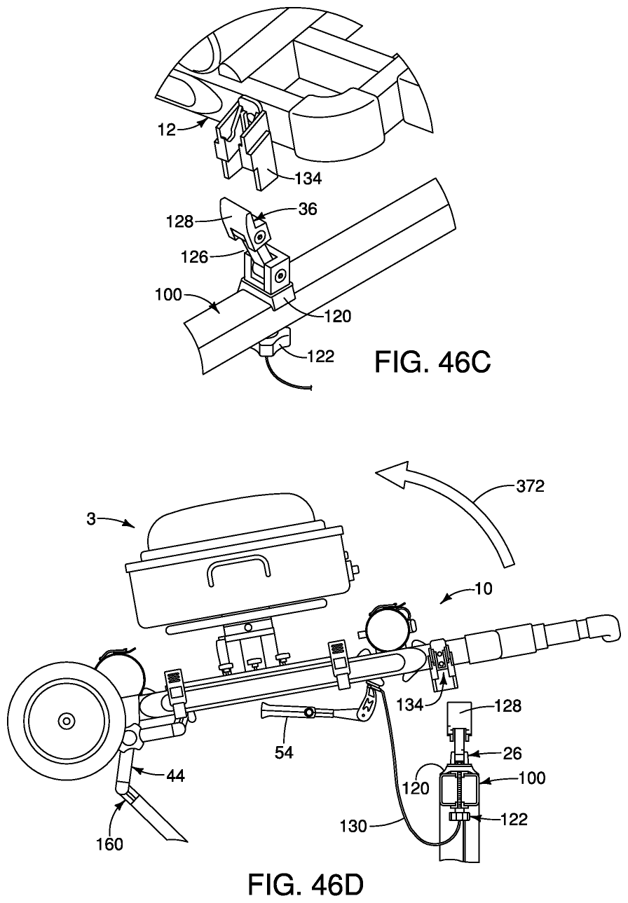

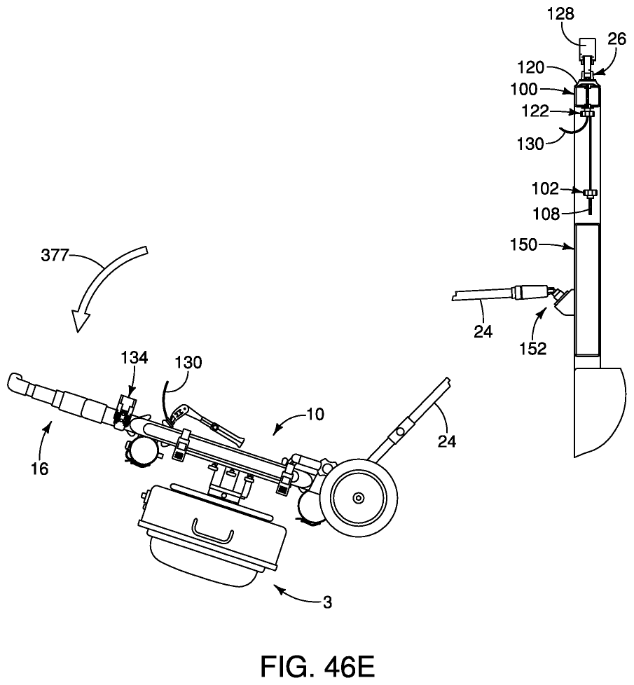

Referring for FIGS. 46A-46E, a quick and easy removal of the carriage apparatus 10, and grill 3, from the boat is shown and described according to one embodiment of the invention. The need for a quick and easy removal of the carriage apparatus 10 and grill 3 can be the result of a catastrophic event or emergency such as a grill fire having the potential to sink a boat, or worse, injure people on the boat. Referring to FIG. 46A, the frame 12 with grill 3 (not shown) is illustrated secured to rail 100 of a boat (not shown).

Referring to FIG. 46B, an emergency has occurred such as a grill fire (not shown) and the grill 3 needs to be removed from the boat quickly and safely. A hand 371 has thumbs (not referenced) engaging the respective inside surfaces 36 of the engagement bodies 128 of the quick-release connectors 26 and forcing the engagement bodies 128 off the respective stationary bodies 134. As explained previously, this action on the quick-release connectors 26 releases the carriage apparatus 10 and grill 3 from the rail 100 of the boat.

Referring to FIG. 46C, the frame 12 (and carriage apparatus 10 and grill 3 (not shown)) can be lifted from the rail 100 of the boat (not shown).

Referring to FIG. 46D, the frame 12 of carriage apparatus 10 with grill 3 is lifted away from rail 100 in direction path 372.

Referring to FIG. 46E, the carriage apparatus 10 with the grill 3 continues being lifted along path direction 372 of FIG. 46D until the carriage apparatus 10 pivots and rotates on the stabilizer bar 24 about the male connector 152 to continue along a direction path 377. As the carriage apparatus 10 with the grill 3 continues along the direction path 377, the stabilizer bar 24 and cable 130 break to release the carriage apparatus 10 and grill from the boat. Accordingly, the grill 3 with the catastrophic fire falls safely and quickly away from the boat (and ideally into the water on which the boat is floating).

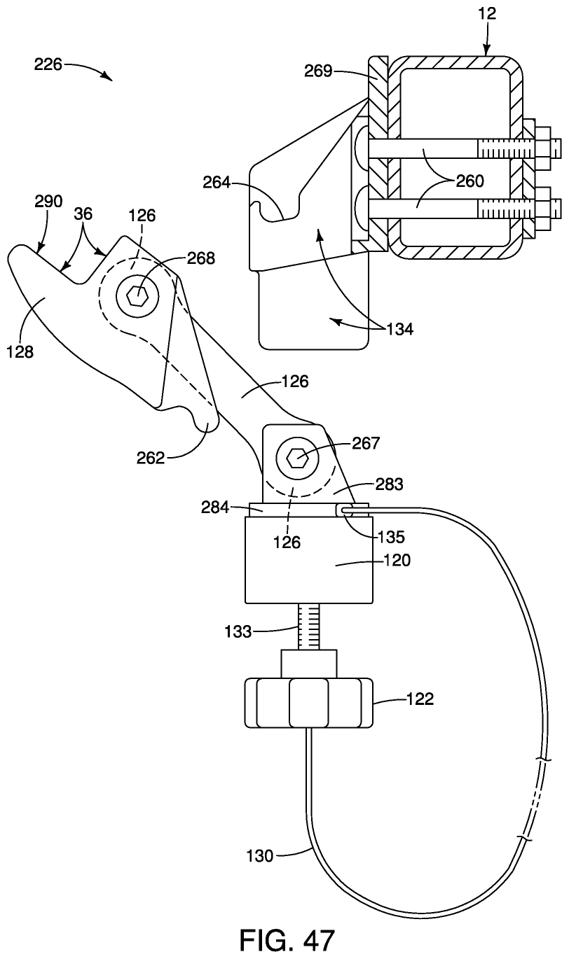

Referring to FIG. 47, another embodiment of a quick-release connector 226 of an exemplary carriage apparatus is illustrated according to another embodiment of the invention. The reference numbers of structures and components for this embodiment of quick-release connector 226 will be the same as the reference numbers used for the same structures and components of the previously described embodiments of the quick-release connectors. The difference in this embodiment of quick-release connector 226 is that the end of the cable 130 opposite the knob 122 is secured to the planar thin base 284 of the quick-release connector 226. In contrast, previously described quick-release connectors have the end of the cable 130 opposite the knob 122 secured to the frame of the carriage apparatuses. Still referring to FIG. 47, the end of the cable 130 is secured to the planar thin base 284 by an attachment device 135. An exemplary attachment device 135 can be a clasp with a bolt. Alternatively, the end of the cable 130 is secured to the planar thin base 284 by glue, or welding, etc.

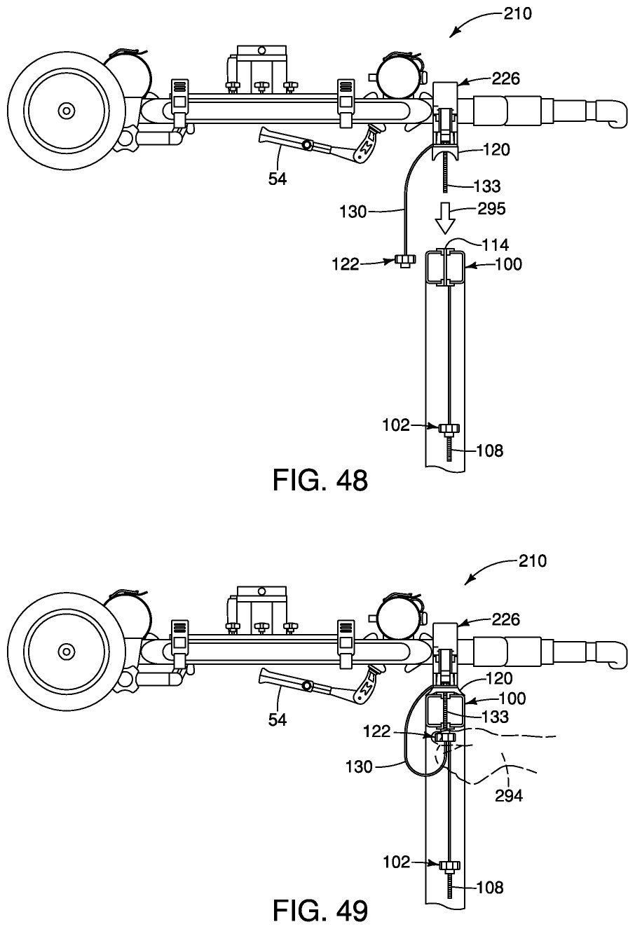

Referring for FIGS. 48-51, utilization of a carriage apparatus 210 having the new embodiment of the quick-release connector 226 is illustrated and described.

Referring to FIG. 48, the carriage apparatus 210 is lowered in direction 295 to move the threaded shanks 133 of the quick-release connectors 226 toward the openings in bushings 114 of rail 100.

Referring to FIG. 49, the threaded shanks 133 of the quick-release connectors 226 are positioned in the bushings 114 of rail 100 and the pressure bearing 120 is pressed against the rail 100 to cushion the securement of the carriage apparatus 10 upon the rail 100 and boat. The knobs 122 are threaded onto the threaded shanks 133 of respective quick-release connectors 226 by hand 294 and tightened to adequately secure the quick-release connectors 226, and therefore the carriage apparatus 210, to the rail 100 and the boat (not shown).

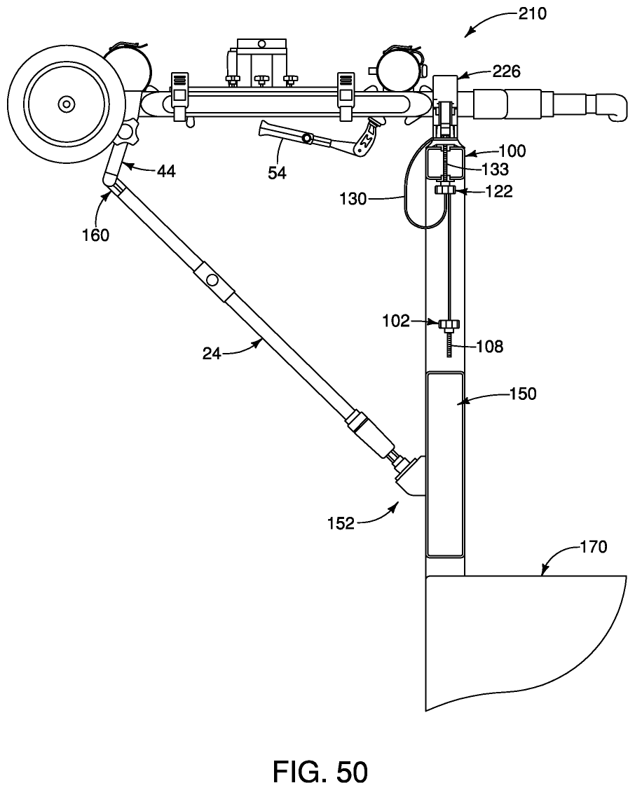

Referring to FIG. 50, the threaded portion 160 of the stabilizer bar 24 is threaded into the connecting bar 44 thereby stabilizing the carriage apparatus 210 on rail 100 of the boat. While not shown, a grill 3 is secured to the carriage apparatus 210 as illustrated and described in FIG. 42.

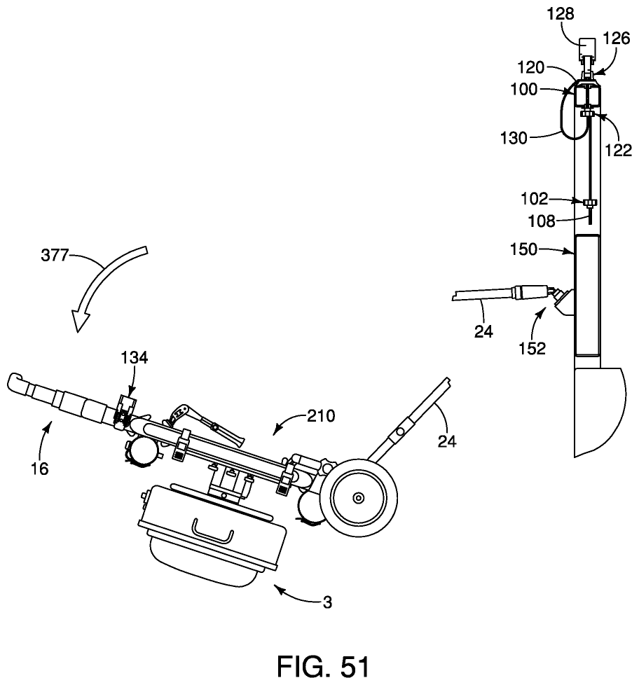

Referring to FIG. 51, a quick and easy removal of the carriage apparatus 210, and grill 3, from the boat is shown and described as the result of a catastrophic event or emergency such as a grill fire. Without being shown, it should be understood that the method steps of the previously described FIGS. 46A-46D have been performed for apparatus 210 and grill 3 in the same manner as previously described for carriage apparatus 10. As illustrated in FIG. 51, the carriage apparatus 210 with grill 3 continues being lifted from rail 100 until the carriage apparatus 210 pivots and rotates on the stabilizer bar 24 about the male connector 152 to continue along a direction path 377. As the carriage apparatus 210 with grill 3 continues along the direction path 377, only the stabilizer bar 24 in this embodiment must break to release the carriage apparatus 210 and grill 3 from the boat. As illustrated, the cable 130 is unbroken since the end opposite the knob 122 remains secured to the planar thin base 284 of the quick-release connectors 226 by attachment device 135. Consequently, the force required to release the carriage apparatus 210 and grill 3 from the boat is diminished relative to the previously described embodiments. It should be understood that the grill 3 with the catastrophic fire falls safely and quickly away from the boat (and ideally into the water on which the boat is floating).

It should be understood that the embodiments of the carriage apparatuses disclosed throughout this document to provide the capability to easily, quickly, conveniently and most importantly safely, remove the risk of fire on a boat resulting from use of a marine grill. The convenience is obvious: a marine grill can be easily transported on the carriage apparatuses and the setup, or breakdown, is without any tools. Still regarding convenience, the marine grill can swivel so that a person can grill while off the boat, for example, standing on a dock. More importantly, the carriage apparatuses disclosed throughout this document allow for a marine grill to be jettisoned from the boat in a manner of 3 to 4 seconds without injury to the person jettisoning or anyone else.

In compliance with the statute, the invention has been described in language more or less specific as to structural and methodical features. It is to be understood, however, that the invention is not limited to the specific features shown and described, since the means herein disclosed comprise preferred forms of putting the invention into effect. The invention is, therefore, claimed in any of its forms or modifications within the proper scope of the appended claims appropriately interpreted in accordance with the doctrine of equivalents.

The invention claimed is:

1. A carriage apparatus for a grill comprising:
a frame comprising a first end opposite a second end;
a pair of wheels secured at the first end of the frame;
a handle extending from the second end of the frame; and
at least one quick-release connector comprising:
a support structure secured to the frame;
a release device supported upon the support structure; and
an elastic member biasing the release device against the support structure.

2. The carriage apparatus of claim 1 further comprising one component of the following two components secured to an upper surface of the frame:
a male component; and
a female component configured to be coupled to the male component.

3. The carriage apparatus of claim 2 wherein the one component is capable of sliding between the first and second ends of the frame.

4. The carriage apparatus of claim 3 further comprising a tightening device configured to selectively prevent the one component from sliding.

5. The carriage apparatus of claim 2 wherein the one component is capable of rotating about an axis extending perpendicularly from the frame.

6. The carriage apparatus of claim 1 further comprising a stand secured to a bottom of the frame and capable of selectively pivoting between a folded position and an extended stand position.

7. The carriage apparatus of claim 1 further comprising a canister secured to the frame.

8. The carriage apparatus of claim 1 further comprising a stabilizer bar configured to be releasably secured to the frame and stabilizing the frame to another structure.

9. A carriage apparatus for a grill comprising:
a frame comprising a first end opposite a second end;
a pair of wheels secured at the first end of the frame;
a handle extending from the second end of the frame; and
one of the following two components secured to an upper surface of the frame:
a male component; and
a female component configured to be coupled to the male component.

10. The carriage apparatus of claim 9 wherein the one component is capable of sliding between the first and second ends of the frame.

11. The carriage apparatus of claim 10 further comprising a tightening device configured to selectively prevent the one component from sliding.

12. The carriage apparatus of claim 9 wherein the one component is capable of rotating about an axis extending perpendicularly from the frame.

13. A method for using a carriage apparatus for a grill, the method comprising:
providing a carriage apparatus comprising:
at least one quick-release connector; and
one of the following two components secured to an upper surface of the frame:
a male component; and
a female component configured to be coupled to the male component; and
utilizing the at least one quick-release connector to releasably secure the carriage apparatus to a boat.

14. The method of claim 13 further comprising securing one end of a stabilizer bar to the carriage apparatus and an opposite end to the boat.

15. The method of claim 13 further comprising utilizing the one component to secure a grill to the carriage apparatus.

16. The method of claim 15 further comprising sliding the grill between ends of the carriage apparatus to adjust the spacing of the grill from the boat.

17. The method of claim 15 further comprising rotating the grill relative to an imaginary axis extending perpendicularly to the carriage apparatus.

18. The method of claim 15 further comprising, upon a desire to remove the grill from the boat, utilizing the at least one quick-release connector to discharge the grill from the boat.
